(19) United States
(12) Patent Application Publication
(10) Pub. No.: US 2013/0025530 A1
(43) Pub. Date: Jan. 31, 2013

(54) CLAMPING BOOKMARKS

(71) Applicant: Franklin Mill, LLC, Salt Lake City, UT (US)

(72) Inventors: Lynn G. Robbins, Centerville, UT (US); S. David Clarke, Centerville, UT (US)

(73) Assignee: FRANKLIN MILL, LLC, Salt Lake City, UT (US)

(21) Appl. No.: 13/646,685

(22) Filed: Oct. 6, 2012

Related U.S. Application Data
(63) Continuation-in-part of application No. 12/749,871, filed on Mar. 30, 2010, now Pat. No. 8,307,777.
Application No. 12/749,871 is a continuation-in-part of application No. 13/157,556, filed on Jun. 10, 2011.

(51) Int. Cl. B42D 9/00

(52) U.S. Cl. 116/237

(57) ABSTRACT

A bookmark can include a ribbon coupled to a clip. The clip can include a rigid body and a display body that are resiliently coupled to each other. The rigid body can include upper and lower attachment regions at which the ribbon is coupled with the clip.

### CROSS REFERENCE TO RELATED APPLICATIONS

This Application is a continuation-in-part of U.S. patent application Ser. No. 12/749,871, filed Mar. 30, 2010, titled BOOKMARKS INCLUDING RIBBON HOLDING FEATURES AND RELATED METHODS, which published as U.S. Patent Application Publication No. 2011/0239929 A1 on Oct. 6, 2011, and this Application is also a continuation-in-part of U.S. patent application Ser. No. 13/157,556, filed Jun. 10, 2011, titled BOOKMARKS INCLUDING COUPLING FEATURES AND RELATED METHODS; the entire contents of each of the foregoing applications and publication are hereby incorporated by reference herein.

### BACKGROUND

The present disclosure relates to bookmarks.

### BRIEF DESCRIPTION OF THE DRAWINGS

The written disclosure describes illustrative embodiments that are non-limiting and non-exhaustive. Reference is made to certain of such illustrative embodiments that are depicted in the figures, in which:

FIG. 1 is a perspective view of an embodiment of a bookmark coupled with a cover flap of a book;

FIG. 2 is a partial front perspective view of the bookmark of FIG. 1;

FIG. 3 is a partial front elevation view thereof;

FIG. 4 is a partial rear elevation view thereof;

FIG. 5 is a partial left elevation view thereof;

FIG. 6 is a partial right elevation view thereof;

FIG. 7 is a partial top plan view thereof;

FIG. 8 is a partial bottom plan view thereof;

FIG. 9 is a rear perspective view of the bookmark of FIG. 1 showing an early stage of coupling a ribbon portion to a rigid body portion thereof;

FIG. 10 is a rear perspective view of the bookmark of FIG. 1 showing a the ribbon fully coupled with the rigid body portion;

FIG. 11 is a front perspective view of another embodiment of a bookmark;

FIG. 12A is a cross-sectional view of another embodiment of a bookmark coupled with a spine of a book;

FIG. 12B is an expanded view of the bookmark of FIG. 12A coupled with the spine of a book taken along the view line 12B in FIG. 12A;

FIG. 13 is a partial front perspective view of the bookmark of FIG. 12A;

FIG. 14 is a partial front elevation view thereof;

FIG. 15 is a partial rear elevation view thereof;

FIG. 16 is a partial left elevation view thereof;

FIG. 17 is a partial right elevation view thereof;

FIG. 18 is a partial top plan view thereof;

FIG. 19 is a partial bottom plan view thereof;

FIG. 20 is a partial front perspective view of another embodiment of a bookmark;

FIG. 21 is a partial front elevation view thereof;

FIG. 22 is a partial rear elevation view thereof;

FIG. 23 is a partial left elevation view thereof;

FIG. 24 is a partial right elevation view thereof;

FIG. 25 is a partial top plan view thereof;

FIG. 26 is a partial bottom plan view thereof;

FIG. 27 is a partial front perspective view of another embodiment of a bookmark;

FIG. 28 is a partial rear perspective view thereof;

FIG. 29 is a partial front perspective view of another embodiment of a bookmark.

FIG. 30A is a front perspective view of an embodiment of a bookmark base of another embodiment of a bookmark;

FIG. 30B is a rear perspective view of the bookmark base of FIG. 30A;

FIG. 30C is a side elevation view of the bookmark base of FIG. 30A;

FIG. 31 is an enlarged view of a lower portion of the bookmark base of FIGS. 30A and 30B taken along the view line 31 in FIG. 30A;

FIG. 32A is a front perspective view of the bookmark base of FIG. 30A illustrating an early stage of coupling an embodiment of a ribbon with the bookmark base so as to form a bookmark;

FIG. 32B is a rear perspective view of that which is shown in FIG. 32A;

FIG. 33A is a front perspective view of the bookmark base of FIG. 30A illustrating a later stage of coupling the ribbon with the bookmark base;

FIG. 33B is a rear perspective view of that which is shown in FIG. 33A;

FIG. 34A is a front perspective view of the bookmark base of FIG. 30A illustrating a later stage of coupling the ribbon with the bookmark base;

FIG. 34B is a rear perspective view of that which is shown in FIG. 34A;

FIG. 35 is a perspective view of an embodiment of an assembled bookmark coupled with a binding region of a book;

FIG. 36 is a front perspective view of a another embodiment of a bookmark base and an embodiments of a ribbon that can be coupled with each other so as to form a bookmark;

FIG. 37 is a front perspective view of the bookmark base of FIG. 36 showing an early stage of coupling the ribbon thereto;

FIG. 38 is a front perspective view of the bookmark base of FIG. 36 showing a later stage of coupling the ribbon thereto;

FIG. 39 is a rear perspective view of the bookmark base of FIG. 36 showing a later stage of coupling the ribbon thereto;

FIG. 40 is a rear perspective view of the fully assembled bookmark that includes the components of FIG. 36;

FIG. 41 is a front perspective view of an embodiment of a kit that includes another embodiment of a bookmark base;

FIG. 42A is a front perspective view of another embodiment of a bookmark;

FIG. 42B is a rear perspective view of the bookmark of FIG. 42A;

FIG. 43A is a perspective view of an early stage of coupling the bookmark of FIG. 42A with a cover of a book;

FIG. 43B is a perspective view of a later stage of coupling the bookmark of FIG. 42A with the cover of the book;

FIG. 44A is a front perspective view of an embodiment of a base portion of the bookmark of FIG. 42A;

FIG. 44B is a front plan view of the base of FIG. 44A;

FIG. 44C is a rear plan view of the base of FIG. 44A;

FIG. 44D is a left side elevation view of the base of FIG. 44A;

FIG. 44E is a right side elevation view of the base of FIG. 44A;

FIG. 44F is a top plan view of the base of FIG. 44A;

FIG. 44G is a bottom plan view of the base of FIG. 44A;

FIG. 45A-45D are side elevation views of various stages of coupling the bookmark of FIG. 42A with the cover of a book;

FIG. 46A is a front perspective view of another embodiment of a bookmark;

FIG. 46B is a rear perspective view of the bookmark of FIG. 46B;

FIG. 47A is a front perspective view of another embodiment of a bookmark;

FIG. 47B is a rear perspective view of the bookmark of FIG. 47A;

FIG. 48A is a front perspective view of an embodiment of a base portion of the bookmark of FIG. 47A;

FIG. 48B is a front plan view of the base of FIG. 48A;

FIG. 48C is a rear plan view of the base of FIG. 48A;

FIG. 48D is a left side elevation view of the base of FIG. 48A;

FIG. 48E is a right side elevation view of the base of FIG. 48A;

FIG. 48F is a top plan view of the base of FIG. 48A; and

FIG. 48G is a bottom plan view of the base of FIG. 48A.

### DETAILED DESCRIPTION

Various embodiments of bookmarks are disclosed herein that provide advantages over known bookmark designs. Some embodiments of the bookmarks are well-suited for attachment to a cover flap of a book (e.g., the cover of a hardback or paperback book), while other embodiments are well-suited for insertion into a spine of a book (e.g., the spine of a hardback book). In some embodiments, a ribbon can be attached to a base portion of a bookmark without using adhesives or other attachment mechanisms (e.g., the ribbon may be held in place by friction alone). In other or further embodiments, an adhesive may be used to attach a ribbon to the bookmark, and in further embodiments, the ribbon may be looped through a portion of the bookmark and attached to itself (e.g., via an adhesive). In some embodiments, a base portion of a bookmark includes a coupling assist feature, which can aid in coupling the bookmark to the cover of a book. In other or further embodiments, the bookmark can be well-suited for coupling with either paperback or hardback books. Other or further advantages are also possible, as will be appreciated from the drawings and discussion. The features described with respect to the various embodiments may be combined in any suitable fashion.

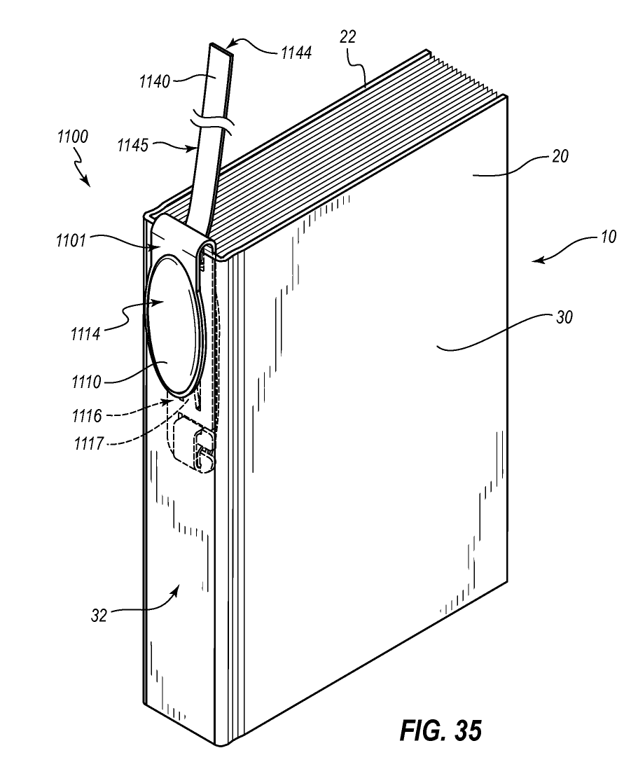

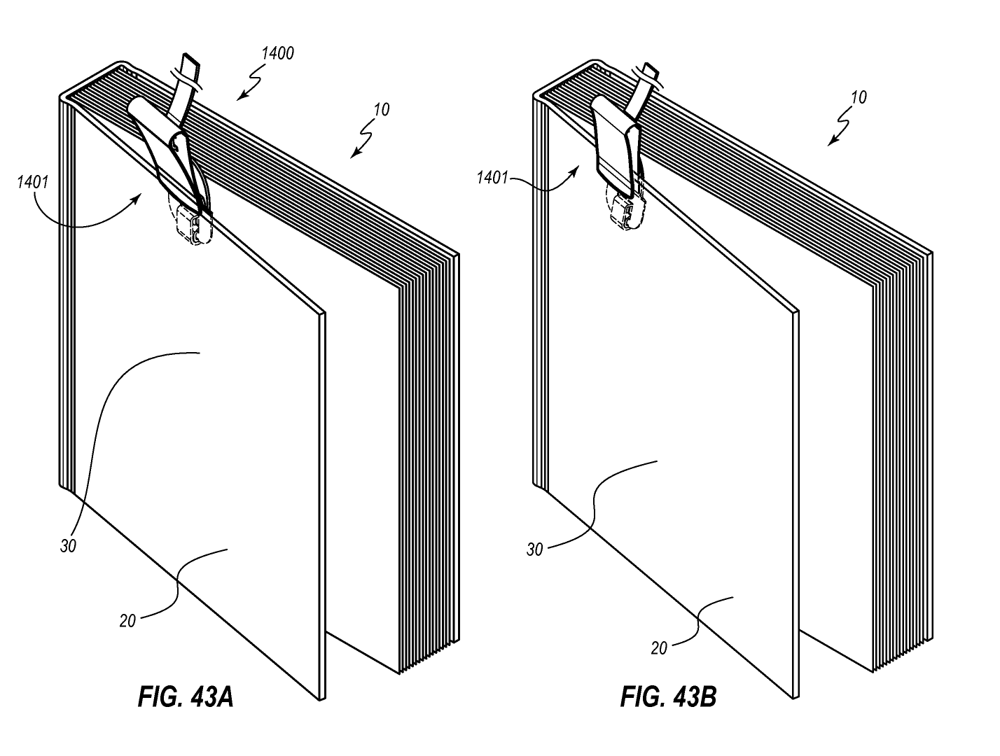

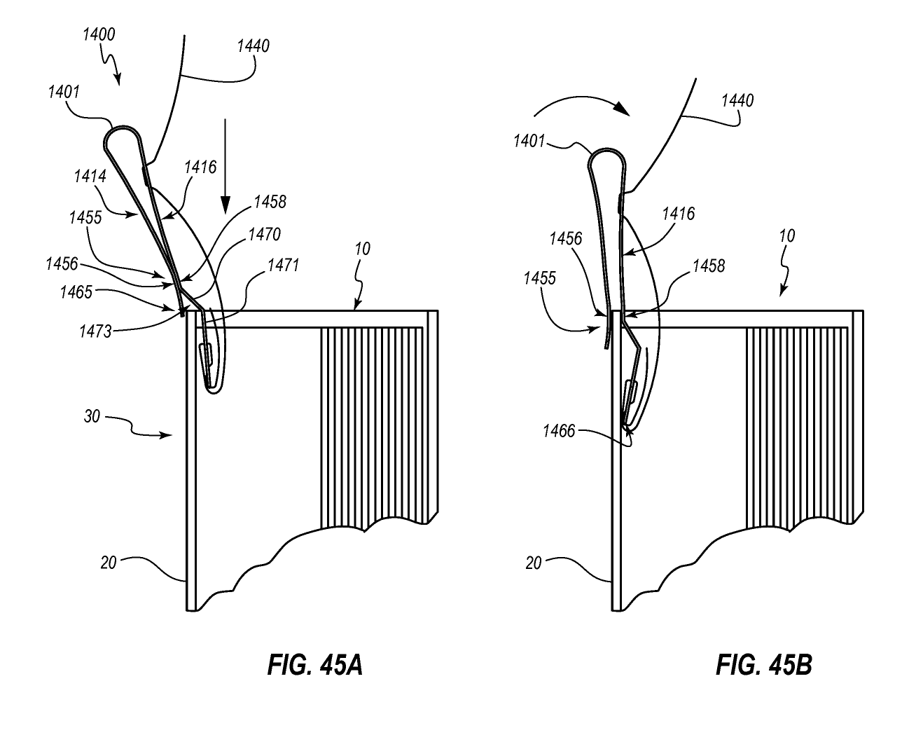

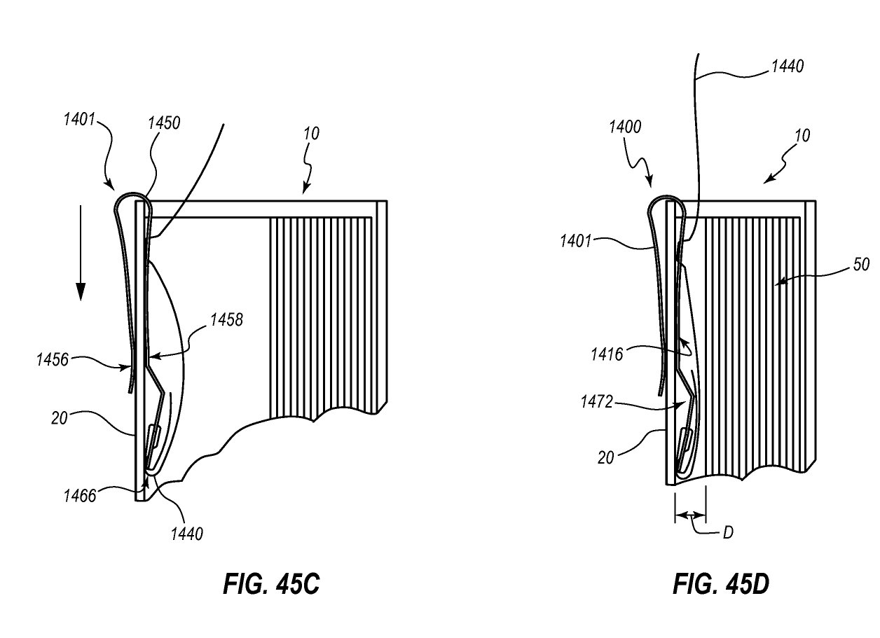

Some embodiments of bookmarks disclosed herein can include both a base portion, which is configured to be coupled with the book in some fashion, and a ribbon portion, which is attached to the base and includes one or more free end portions that can be inserted between pages of the book as a placeholder. The base portions of the bookmarks may be coupled with a variety of books in various fashions. For example, certain embodiments of bookmarks include a rigid body that can be inserted into the spine of a book, and an end of the ribbon can extend outwardly away from the spine (see, e.g., FIG. 35). In other or further embodiments, the base portion of the bookmark may be inserted behind a cover flap (e.g., front or back cover flap) of the book, which may be of either a paperback or hardback variety (see, e.g., FIGS. 43A-43B and 45A-45D).

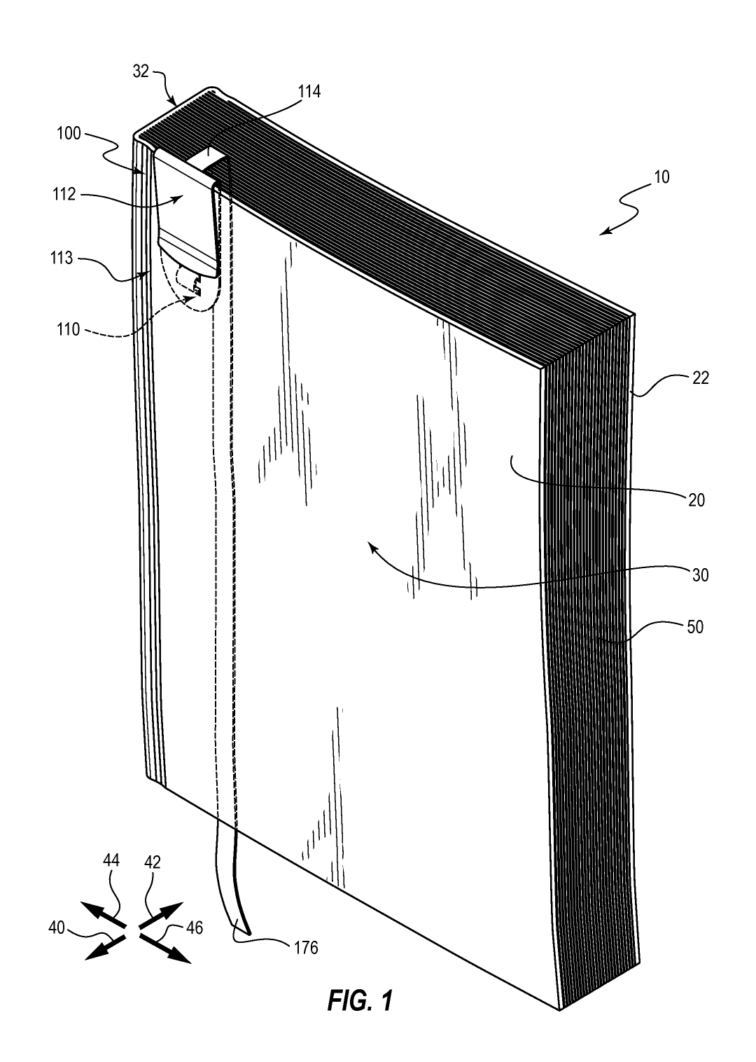

FIG. 1 illustrates an embodiment of a bookmark 100 coupled with a book 10. In particular, the bookmark 100 is attached to the book 10 at an upper end of a front cover flap 20 of the book 10. The book 10 may be of a hardback or paperback variety, and can also include a back cover flap 22. As is common for many varieties of books, a single outer covering 30 can comprise both the front and back cover flaps 20, 22. Moreover, the covering 30 can extend between the front cover flap 20 to the back cover flap 22 so as to cover a spine 32 of the book 10. The spine 32 is discussed further below.

The terms “front” and “back” are used in their ordinary sense herein when referring to the book 10. For ease of reference, a similar set of directional terms is used with respect to the bookmark 100. In particular, the terms “forward,” “front,” and variations thereof refer to a direction that progresses outwardly from a central portion of the book 10 when the bookmark 100 is attached thereto. For example, when the bookmark 100 is attached to the front cover flap 20, as shown in FIG. 1, the forward direction relative to the bookmark 100 is shown at arrow 40. Similarly, the terms “rearward,” “rear,” and variations thereof refer to a direction that progresses toward a central portion of the book 10 when the bookmark 100 is attached thereto. For example, when using the front cover flap 20 as a reference point, a rearward direction is shown at arrow 42. Using the spine 32 as a reference point (which can be particularly applicable for embodiments discussed below), a forward direction is shown at arrow 44, whereas a rearward direction is shown at arrow 46. Other directional terms, such as “left” and “right,” are used herein from a perspective looking in the rearward direction.

As shown in phantom lines, and as discussed further hereafter, the bookmark 100 can include a rigid body 110, which can be inserted between the front cover flap 20 of the book 10 and the pages 50 of the book. The bookmark 100 can further include a clamp-like display body 112 that extends forwardly over the front cover flap 20 and cooperates with the rigid body 110 to attach the bookmark 100 to the cover flap 20. Together, the rigid body 110 and the display body 112 may be referred to as a clip 113. The bookmark 100 also can include a ribbon 114 that is attached to the clip 113. The ribbon 114 can be selectively draped over any desired number of the pages 50 and extended between adjacent pages 50 so as to serve as a placeholder.

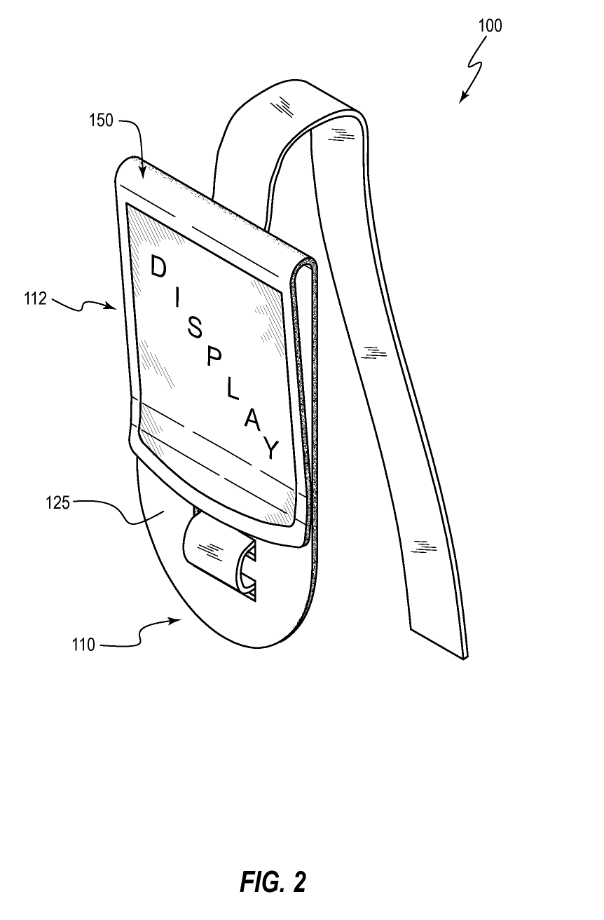

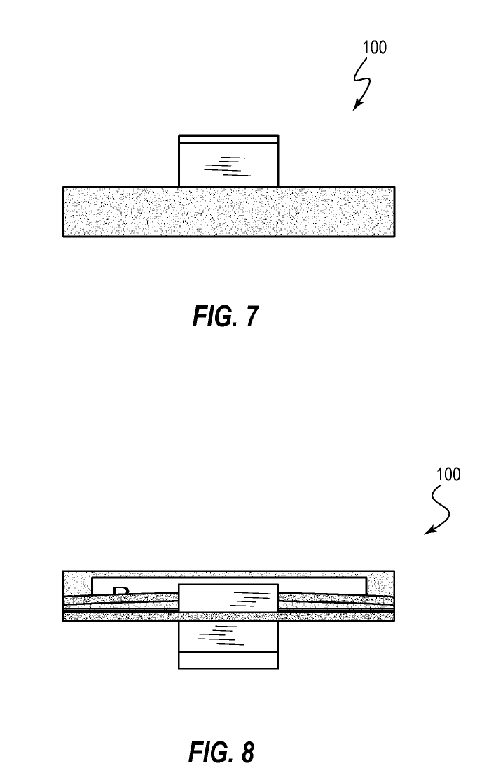

FIGS. 2-8 illustrate various views of an embodiment of the bookmark 100 in an assembled state. As shown in at least some of the views, the rigid body 110 of the bookmark 100 can define an upper end 120, a lower end 121, a left edge 122, a right edge 123, a lower edge 124, a front face 125, and a rear face 126. The upper end 120 can include a catch 130 therein. The catch 130 may also be referred to as an attachment region, a holding feature, and/or as a pivot point. The catch 130 can be used in attaching the ribbon 114 to the rigid body 110, and in further instances, can be configured to stabilize the ribbon 114 relative to an additional attachment region (e.g., an attachment region 140, which is discussed below with respect to FIG. 4), such as to prevent pivoting or rotational movement of the ribbon 114 within a region of the ribbon 114 that extends between the catch 130 and the further attachment region.

In the illustrated embodiment, the catch 130 comprises a laterally extending protrusion 132 that is encompassed on three sides by an opening 134. As shown in FIGS. 4-6, a rear surface of the protrusion 132 can be flush with the rear face 126 of the rigid body 110. Such an arrangement can prevent the protrusion 132 from marring or indenting the pages 50 of the book 10. In other embodiments, the protrusion 132 may be recessed relative to the rear face 126 (e.g., may be at a position that is forward of the rear face 126), and in still other embodiments, the protrusion 132 may project outwardly from the rear face 126 in addition to extending laterally (e.g., may be at a position that is rearward of the rear face 126). The opening 134 can be sized to permit the ribbon 114 to extend therethrough on either side of the protrusion 132, as shown in FIGS. 4-6.

With reference to FIG. 4, the rigid body 110 can define an attachment region 140 at which the ribbon 114 can be secured to the rigid body 110. In the illustrated embodiment, the attachment region 140 includes two laterally extending openings 142. The openings 142 can be relatively close to each other, and can define a holding bar 144 therebetween.

In some embodiments, the catch 130 (which may also be referred to as an upper catch or upper attachment region), can more closely resemble the attachment region 140 (which may also be referred to as a lower catch or lower attachment region). For example, in some embodiments, the catch 130 may comprise a holding bar having discrete openings above and below it, rather than the lateral protrusion 132 that is bordered on three sides by an opening, such that the protrusion 132 has a free-end arrangement. Or, in other embodiments, the attachment region 140 may have protrusion with a C-shaped opening extending about it, such as the catch 130 arrangement depicted in FIG. 4.

The display body 112 can be connected to the rigid body 110 via a transition region 150. In the illustrated embodiment, the transition region 150 defines a rounded profile and extends from the upper end 120 of the rigid body 110 to a top end 152 of the display body 112. The transition region 150 can be resiliently deformable so as to bias a bottom end 154 of the rigid body 110 toward the rigid body 110. Together, the transition region 150 and the display body 112 can be referred to as a biasing member 156. In some embodiments, the rigid body 110, the display body 112, and the transition region 150 may be unitarily formed of any suitable material, such as, for example, metal or plastic.

In a natural or resting state, the display body 112 can be angled from the transition region 150 toward a clamping region 158 of the rigid body 110. The clamping region 158 and the bottom end 154 thus can cooperate with each other to clamp the cover flap 20 of the book 10 therebetween. In the illustrated embodiment, a left edge 160 and a right edge 162 of the display body 112 are substantially aligned with the left and right edges 122, 123 of the rigid body 110, respectively. In particular, the left edges 122, 160 and the right edges 123, 162 can be coextensive at the clamping region 158. Stated otherwise, an effective area of the clamping region 158 can extend along substantially a full width of the bookmark 100, which can provide for an even attachment force.

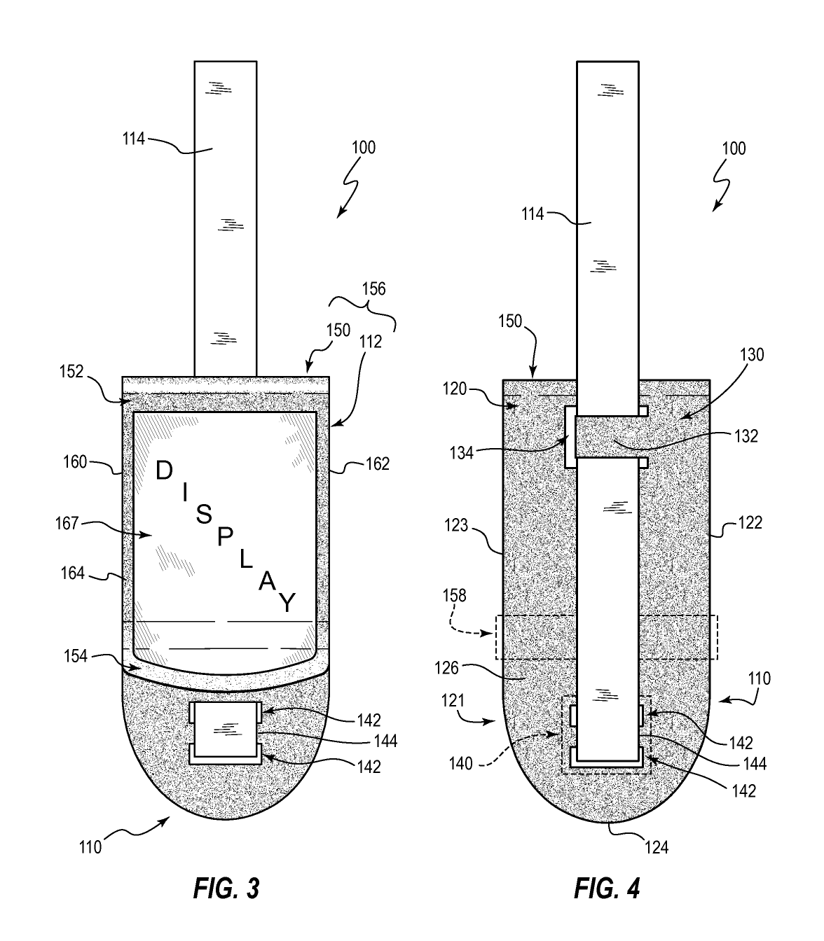

As can be seen in FIGS. 3, 5, and 6, the bottom end 154 of the display body 112 can be spaced from the openings 142 of the attachment region 140. This can permit the ribbon 114 to be readily passed through the openings 142 and looped about the holding bar 144. Stated otherwise, the ribbon 114 can be passed through the openings 142 without hindrance from the display body 112.

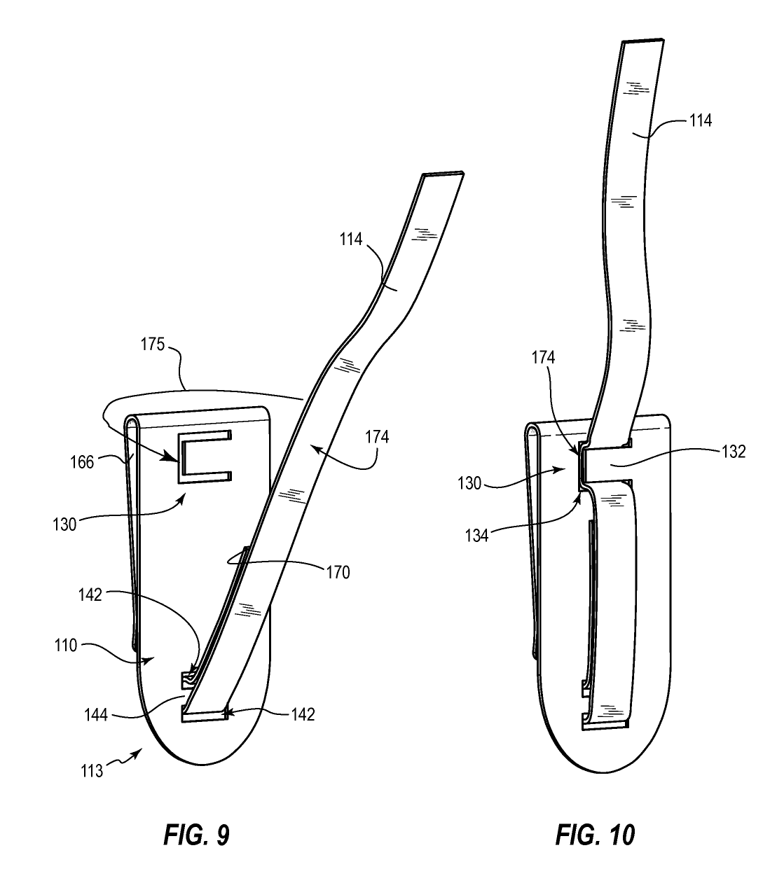

The display body 112 can include a front face 164 (see FIG. 3) and a rear face 166 (see FIG. 9). The front face 164 can include a display region 167 at which any suitable display may be provided, such as, for example, a decorative sticker, printed image, or raised or etched design. A rear face 166 of the display body 112 can face toward the front face 125 of the rigid body 110.

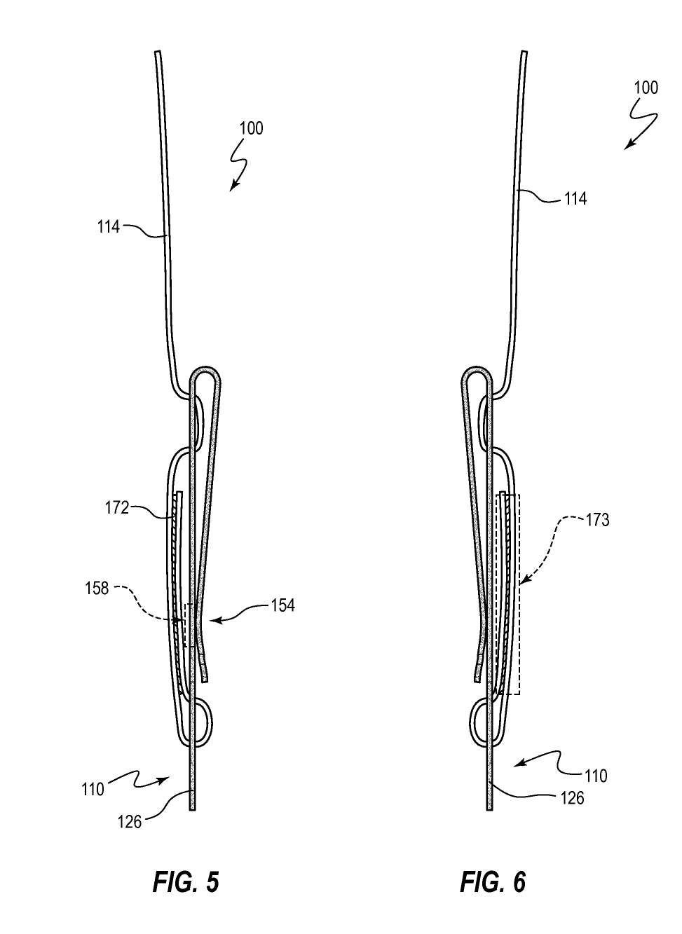

With reference to FIG. 9, a method of attaching the ribbon 114 to the clip 113 comprises inserting a distal end 170 of the ribbon 114 through one of the openings 142 of the rigid body 110 in a forward direction, looping the distal end 170 about the holding bar 144, and passing the distal end 170 through another opening 142 in a rearward direction. The distal end 170 of the ribbon 114 can then be attached to another portion of the ribbon 114 via an adhesive 172 (see FIG. 5) or in any other suitable manner. It may be said that the distal end 170 of the ribbon 114 is attached to the other portion of the ribbon 114 (e.g., the intermediate segment) in a variety of arrangements, including those in which the extreme distal edge of the distal end 170 is not itself directly attached to the other portion of the ribbon. Stated otherwise, the adhesive 172 need not necessarily contact or otherwise extend all the way to the distal edge of the distal end 170 of the ribbon 114 in order to attach the distal end 170 of the ribbon 114 to another portion of the ribbon 114, although such an arrangement would also qualify as an attachment of the distal end 170 of the ribbon to the other segment of the ribbon.

In some embodiments, the adhesive 172 can be permanent such that the ribbon 114 cannot readily be removed. In other embodiments, the adhesive 172 can be non-permanent or relatively temporary, such that the ribbon 114 may be removable and replaceable, as further discussed below. In still other embodiments, a different attachment mechanism may be used to secure the ribbon 114 to itself, such as, for example, a crimping sleeve or other suitable fastener (whether permanent or temporary). The ribbon 114 may be attached to itself in a connection region 173 (see FIG. 6).

With reference to FIGS. 9 and 10, an intermediate segment 174 of the ribbon 114 can be introduced into the opening 134 of the catch 130 and in front of the transverse protrusion 132, as shown at the arrow 175 (FIG. 9). The catch 130 can provide sufficient frictional force to secure the intermediate segment 174 in place. Stated otherwise, the catch 130 can clamp the ribbon 114 so as to substantially prevent inadvertent lengthening or shortening of the portion of the ribbon 114 that extends between the openings 142 of the rigid body 110 and the opening 134 of the catch 130. In some embodiments, once the ribbon 114 is within the catch 130, the ribbon 114 may be pulled so as to tighten the portion of the ribbon 114 that is between the openings 142, 134. Stated otherwise, the ribbon 114 may be taut between the openings 142, 134 so as to define a low profile relative to the rear face 126 of the rigid body 110. For example, the ribbon 114 may be drawn into closer proximity to the rear face 126 than what is shown in FIGS. 5 and 6.

In the illustrated embodiment, the distal end 170 of the ribbon 114 serves to attach the ribbon 114 to the clip 113 and a proximal end 176 (see FIG. 1) of the ribbon 114 is free, such that it can be used in marking a place in the book 10. In other embodiments, a more central portion of the ribbon 114 can be adhered to itself and two strands of the ribbon 114 may be held within a catch 130 such that both ends 170, 176 of the ribbon may be free and used to mark places in the book 10. In still other embodiments, two or more ribbons 114 may be inserted through the two openings 142 of the rigid body 110 and/or additional ribbons 114 may be inserted through additional openings 142 in the rigid body 110.

The ribbon 114 can comprise any suitable material. For example, the ribbon 114 can be formed of one or more synthetic materials (e.g., polyester, nylon, polypropylene) and/or one or more cloth or natural materials (e.g., silk, velvet cotton, jute). In some embodiments, the ribbon 114 is relatively flexible and can be configured to drape readily over pages of a book. For example, the ribbon 114 can be substantially non-resilient, and thus may not have a natural shape to which the ribbon 114 returns when displaced from that shape. Other suitable materials and properties of the ribbon 114 are possible.

In some embodiments, it can be desirable for the ribbon 114 to be only selectively attached to the clip 113, or stated otherwise, it may be desirable to readily remove the ribbon 114 from the clip 113. For example, different colored ribbons 114 may be desired for use with different books such that one colored ribbon 114 may be replaced with another. An arrangement such as that shown in FIGS. 5 and 6 can help to prevent inadvertent or premature removal of the ribbon 114, as movement of the region of the ribbon 114 that bears the adhesive 172 is inhibited.

With reference again to FIG. 1, when the illustrated embodiment of the bookmark 100 is coupled with the book 10 and the book 10 is closed, the connection region 173 of the ribbon 114 is hidden. This can enhance the aesthetics of the bookmark. Moreover, in the illustrated arrangement, the ribbon 114 is constrained to move, or pivot, relative to a single location at an upper end of the clip 113. This likewise can be visually appealing. Such an arrangement also can inhibit damage to the upper edges of the pages 50 that are nearest the cover flap 20 as the free end of the ribbon 114 is moved.

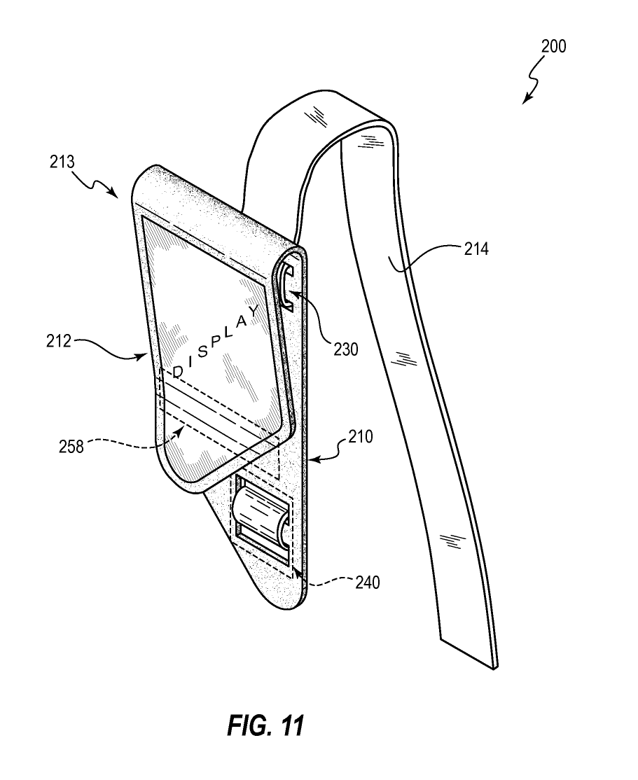

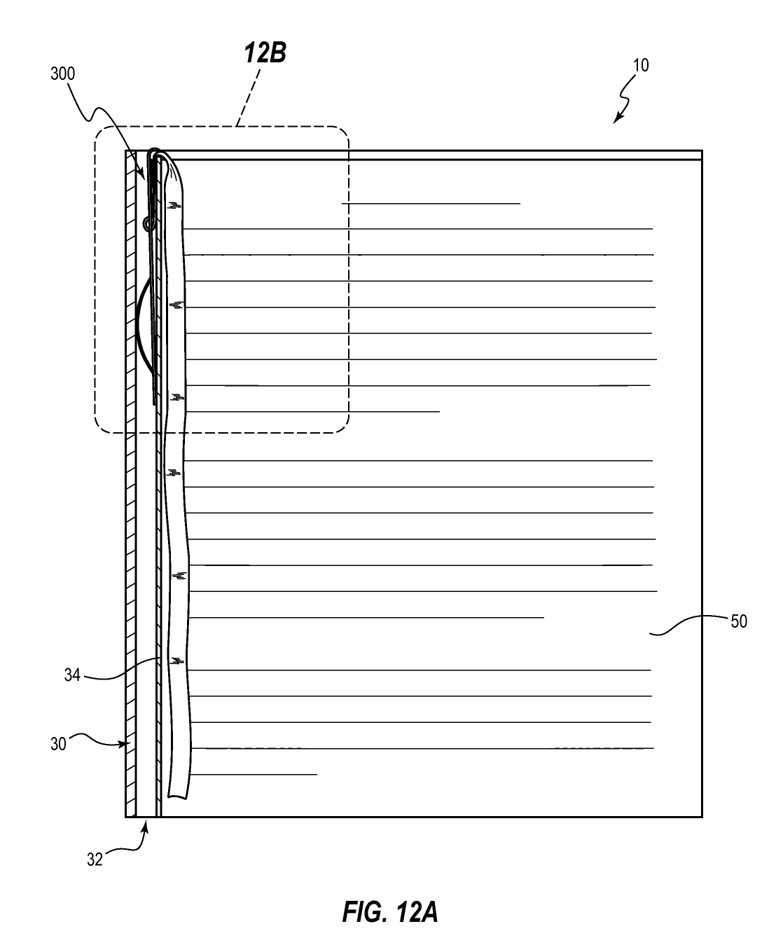

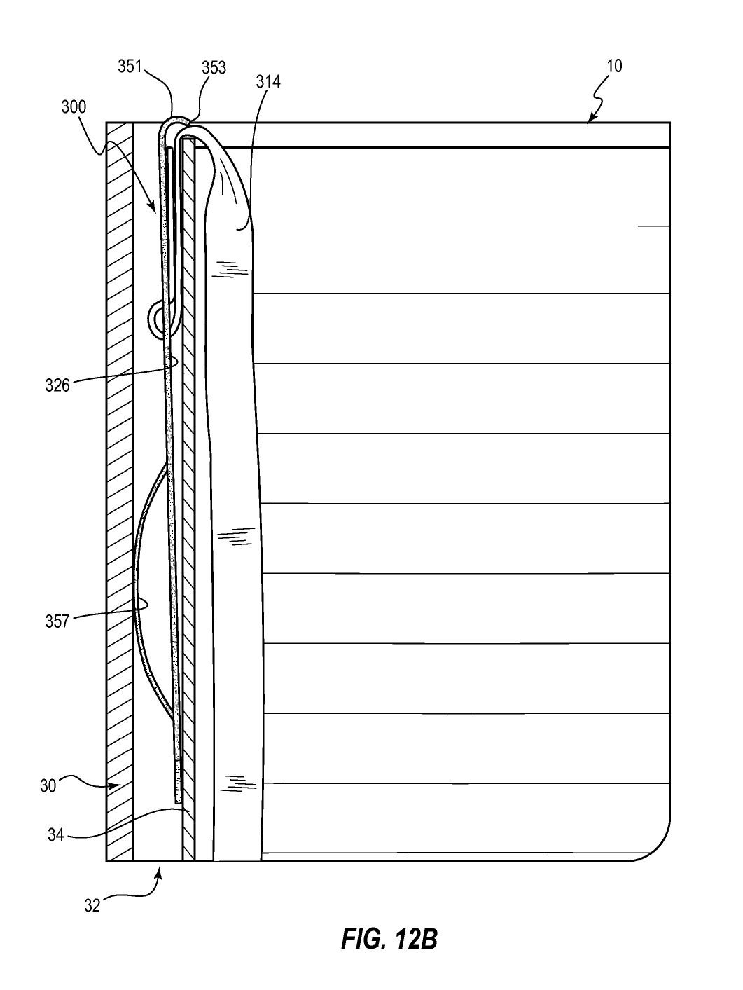

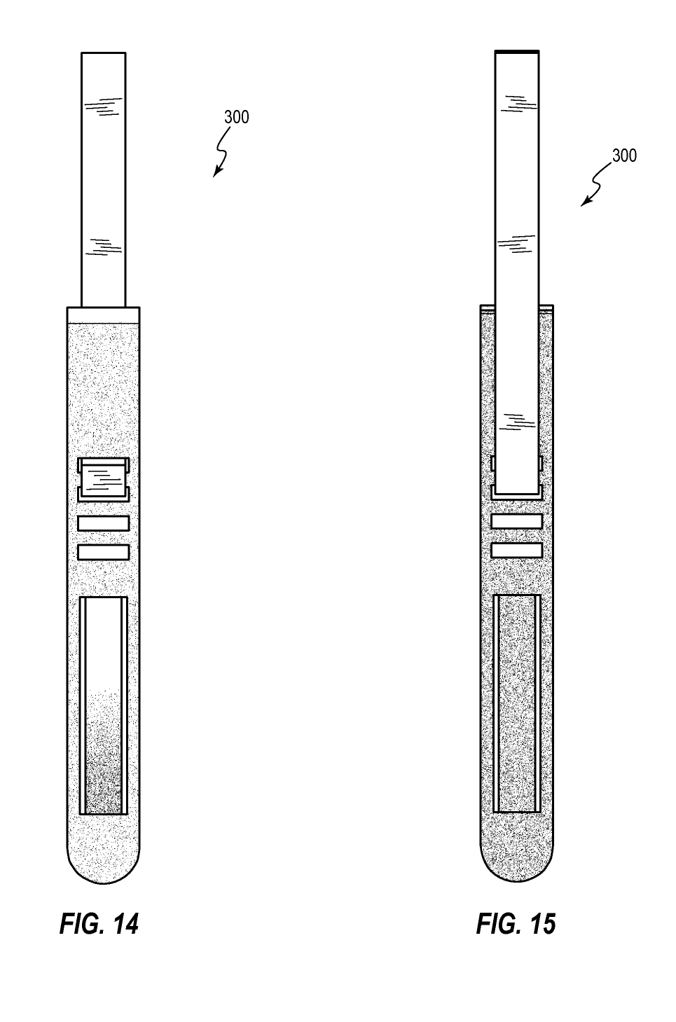

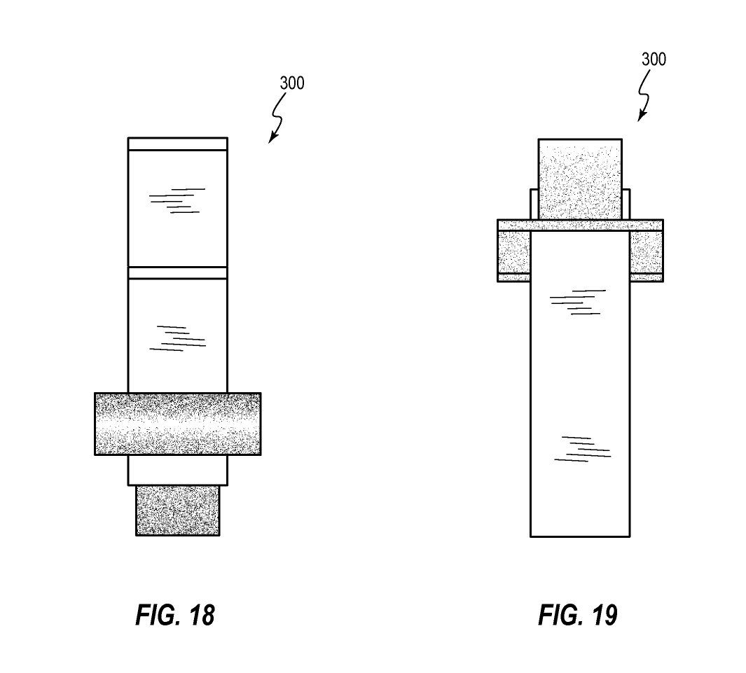

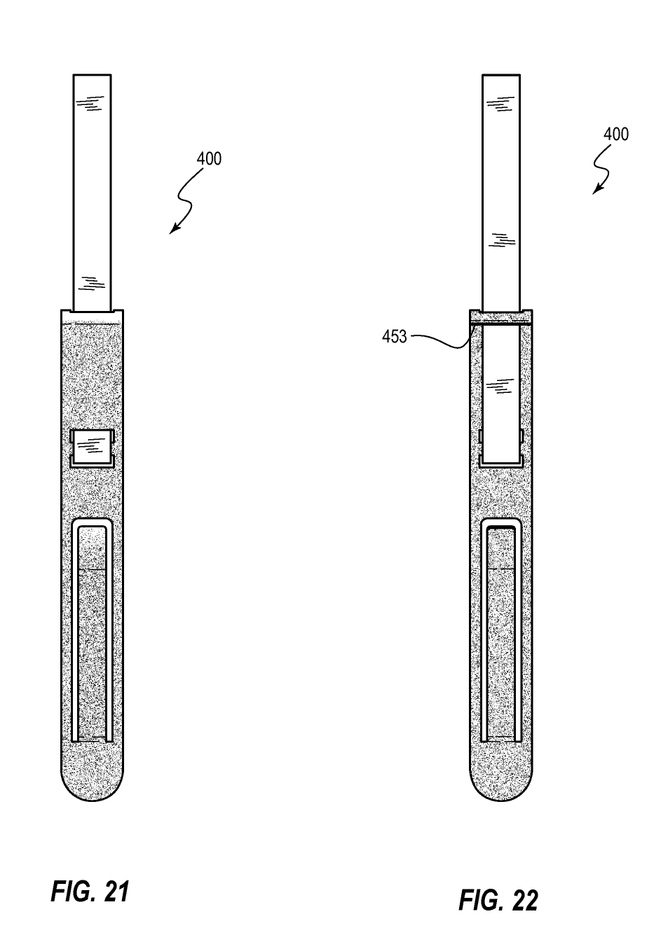

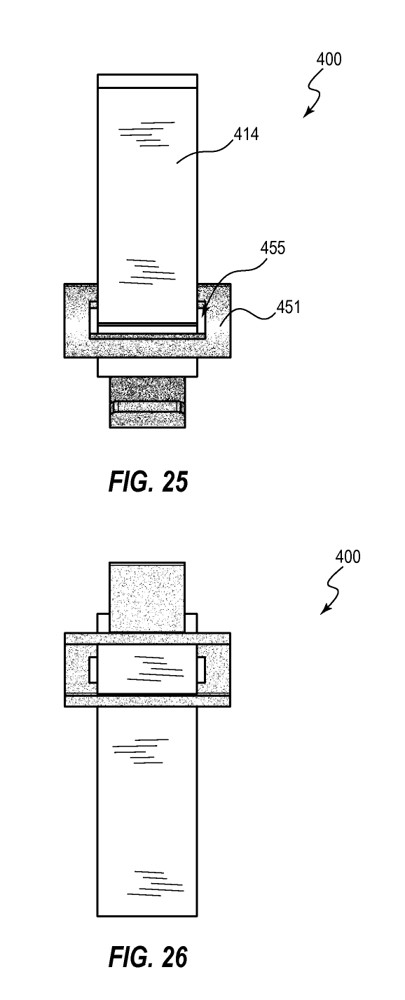

FIG. 11 illustrates another embodiment of a bookmark 200, which can resemble the bookmark 100 described above in certain respects. Accordingly, like features are designated with like reference numerals, with the leading digits incremented to “2.” Relevant disclosure set forth above regarding similarly identified features thus may not be repeated hereafter. Moreover, specific features of the bookmark 200 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the bookmark 200. Any suitable combination of the features and variations of the same described with respect to the bookmark 100 can be employed with the bookmark 200, and vice versa. This pattern of disclosure applies equally to further embodiments depicted in FIGS. 12A-29.

The bookmark 200 includes a clip 213 that includes a rigid body 210 and a display body 212, which are shaped differently from the rigid body 110 and the display body 112. In particular, lower ends of the rigid body 210 and the display body 212 are angular and are offset relative to each other. As with the rigid body 110, the rigid body 210 extends downwardly beyond a lower extent of the display body 212. Accordingly, an attachment region 240 of the rigid body 210 is substantially free of the display body 212.

The rigid body 210 defines a clamping region 258 that does not extend across a full width of the clip 213. However, as with the rigid body 110, the clamping region is at a position above the attachment region 240. The attachment region 240 and a catch 230 are offset relative to a central axis of the clip 213. Likewise, the ribbon 214 is offset relative to the central axis such that it is constrained to pivot at a position that is not at the center of an upper end of the clip 213.

FIGS. 12A and 12B illustrate another embodiment of a bookmark 300 coupled with a hardback book 10. The spine 32 of the hardback book 10 can include the outer covering 30 (which is discussed above) and a binding region 34. The binding region 34 denotes the portion of the hardback book 10 where the pages 50 are bound together. A space is generally present or formable between the outer cover 30 and the binding region 34, and the bookmark 300 is configured to be inserted into this space, as further discussed below.

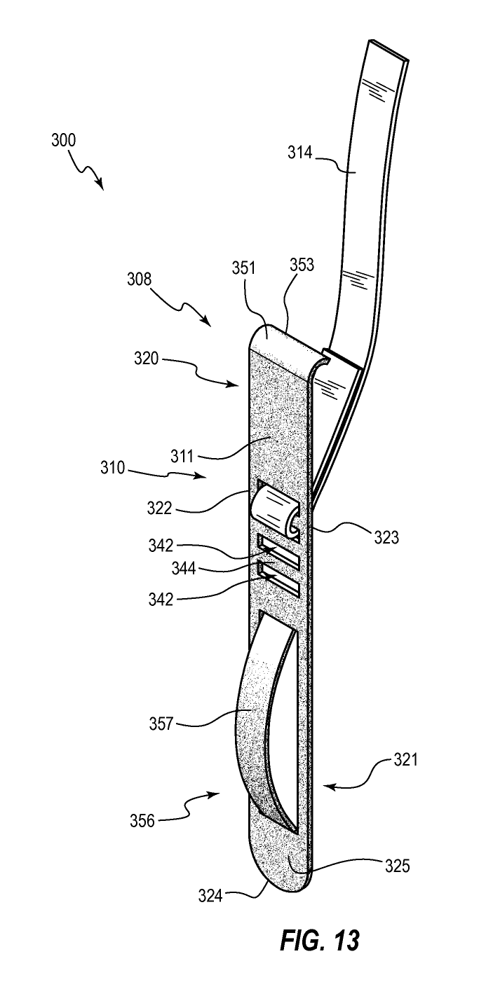

With reference to FIGS. 13-19, the illustrated embodiment of the bookmark 300 can include an insert 308 and one or more ribbons 314 attached (e.g., permanently or selectively attached) to the insert 308. The insert 308 can include a rigid body 310 that defines an upper end 320, a lower end 321, a left edge 322, a right edge 323, a bottom edge 324, a front face 325, and a rear face 326. The rigid body 310 is elongated in a longitudinal direction and thus can be inserted longitudinally into the spine 32 of the book 10, as shown in FIGS. 12A and 12B. In the illustrated embodiment, the rigid body 310 comprises a substantially planar plate 311. The left and right edges 322, 323 of the plate 311 are substantially parallel to each other, and the bottom edge 324 is rounded. A longitudinal length of the plate 311 can be substantially greater than a width of the plate 311. For example, in various embodiments, a length of the plate can be within a range of from about 5 centimeters to about 15 centimeters, from about 7 centimeters to about 12 centimeters, from about 7.5 centimeters to about 8.5 centimeters, or can be no less than about 5, 6, 7, 8, 9, or 10 centimeters, and a width of the plate can be within a range of from about 5 millimeters to about 25 millimeters, from about 10 millimeters to about 20 millimeters, from about 5 millimeters to about 10 millimeters, or from about 15 millimeters to about 25 millimeters, or can be no less than about 5, 6, 7, 8, 9, or 10, 15, 20, or 25 millimeters.

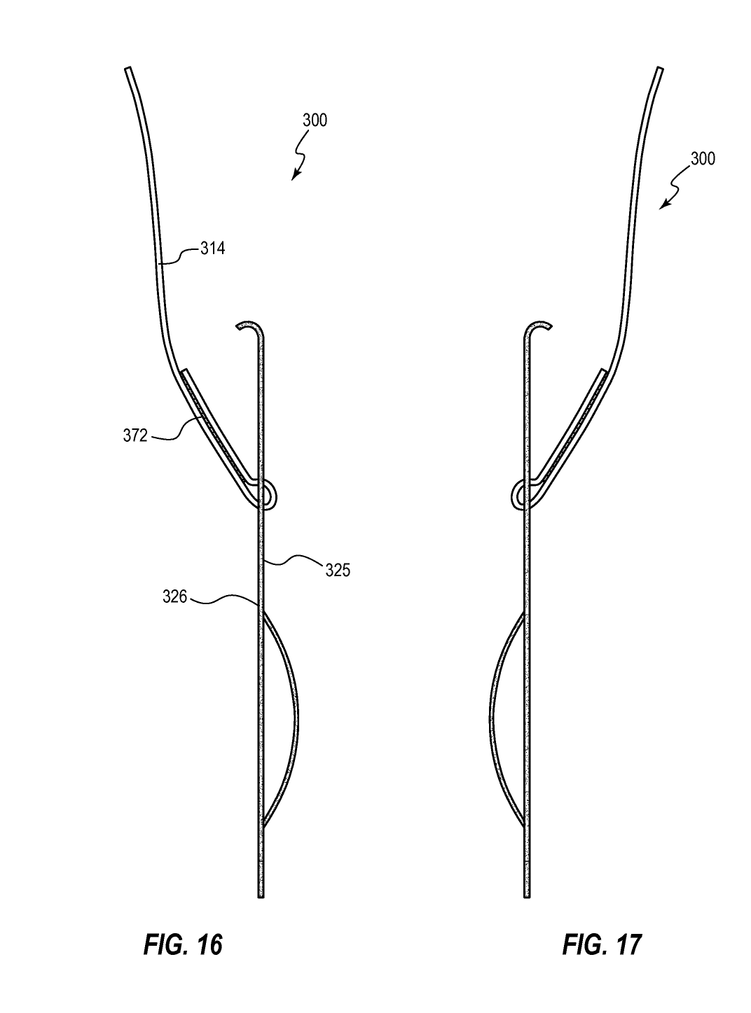

The plate 311 can include a plurality of ribbon openings 342 that extend therethrough. In the illustrated embodiment, the plate 311 includes four ribbon openings 342. In some embodiments, two or more ribbons 314 can be coupled to the plate 311. For example, a first ribbon 314 can be looped through the two top openings 342 and attached to itself via an adhesive 372 (FIG. 16), as shown, and a second ribbon 314 can be similarly attached to the plate 311 via the two bottom openings. Other arrangements of the openings 342 are also contemplated. For example, in some embodiments, the plate 311 may be relatively wide and may include multiple columns (e.g., 2 columns) and multiple rows of openings 342. A set of adjacent openings 342 can define a bar 344 about which the ribbon 314 can be looped.

The insert 308 can further include a biasing member 356, which can extend forwardly from the plate 311. In the illustrated embodiment, the biasing member 356 comprises a substantially arc-shaped stabilizing projection 357 that is joined to the plate 311 at a top and bottom end thereof. By extending forwardly from the plate 311, the projection 357 increases a thickness or depth of the insertion portion of the insert 308.

The projection 357 can be resiliently deformable so as to provide a reactive force when compressed. For example, the projection 357 can comprise a leaf spring. In many embodiments, the projection 357 is configured to be compressed by the outer covering 30 of a book 10 when the insert 308 is inserted into the spine 32 of the book 10, such that the thickness of the inserted portion of the insert 308 decreases. The excess thickness provided by the projection 357 can decrease by different amounts depending on the available space within the spine 32, the stiffness of the covering 30, and/or the stiffness of the projection 357. The projection 357 thus can provide a degree of adjustability or adaptability to the bookmark 300.

The projection 357 can function suitably with books 10 having coverings 30 that have widely varying thicknesses. For example, in the illustrated embodiment, the projection 357 acts against an interior surface of the covering 30 and does not cooperate with any devices positioned at or near an exterior surface of the covering 30 positioned generally at the same longitudinal location of the projection 357, and thus the bookmark 300 can function well with books 30 that have relatively thin coverings 30 as well as books 10 that have relatively thick coverings 30. In some embodiments, a stiffness of the projection 357 can be selected for a particular application of the bookmark 300. For example, if it is desired to use the bookmark 300 with a book 10 having a narrow space between the outer covering 30 and/or a relatively compliant covering 30, then the projection 357 may be selected to be relatively compliant.

The insert 308 can further include a cap, rim, or stop 351, which can be rigid and fixed to the plate 311. In the illustrated embodiment, the stop 351 extends rearwardly from the upper end 320 of the plate 311. The stop 351 can define a contact edge 353, which can be positioned at an end of the stop that is opposite of the plate 311.

With reference again to FIG. 12B, the stop 351 can rest on or over the binding region 32 when the bookmark 300 is inserted into the spine 32. In the illustrated embodiment, the contact edge 353 of the stop 351 contacts the ribbon 314 such that the ribbon 314 is sandwiched between the contact edge 353 and the binding region 34. In the illustrated embodiment, a connection region of the ribbon 314, such as the connection region 173 (see FIG. 6) discussed above, can be hidden from view when the bookmark 300 is inserted into the spine 32 of the book 10.

The stop 351 can prevent the bookmark 300 from being inserted completely into the spine 32. The projection 357 can assist the stop 351 in this task by urging the stop 351 in a rearward direction. Stated otherwise, the projection 357 can urge the rear face 326 of the plate 311 toward the binding region 34 of the book 10, which can cause the stop 351 to extend over the binding region 34 and catch thereon. The stop 351 and the projection 357 can provide multiple points of contact between the bookmark 300 and the book 10. Moreover, in the illustrated embodiment, the top 351 and the projection 357 can provide forces to the book 10 in substantially perpendicular directions. Additionally, the stop 351 and the projection 357 are at substantially opposite ends of the bookmark 300, which can aid in effectively counteracting torques that might otherwise rotate or displace the bookmark 300 relative to the book 10. The stop 351 and the projection 357 thus can cooperate to securely attach the bookmark 300 to the book 10. In some embodiments, a width of the contact edge 353 and/or a surface area of the projection 357 that contacts the outer covering 30 can be increased so as to distribute the forces they provide to a book 10, which can increase stability and/or reduce potential marring of a book.

In some embodiments, the insert 308 can comprise separate pieces that are joined together. In other embodiments, the insert 308 can be unitarily formed of a single piece of material. For example, in some embodiments, the insert 308 may comprise a metal plate that is bent so as to form the insert 308 and stamped so as to form the projection 357. Other manufacturing techniques are contemplated, such as, for example, injection molding.

In some embodiments, the plate 311 can include a catch, such as the catch 130 described above, within the upper end 320 near the stop 351. Such an arrangement may inhibit potential movement between the stop 351 and the ribbon 314 when the bookmark 300 is inserted in a book 10.

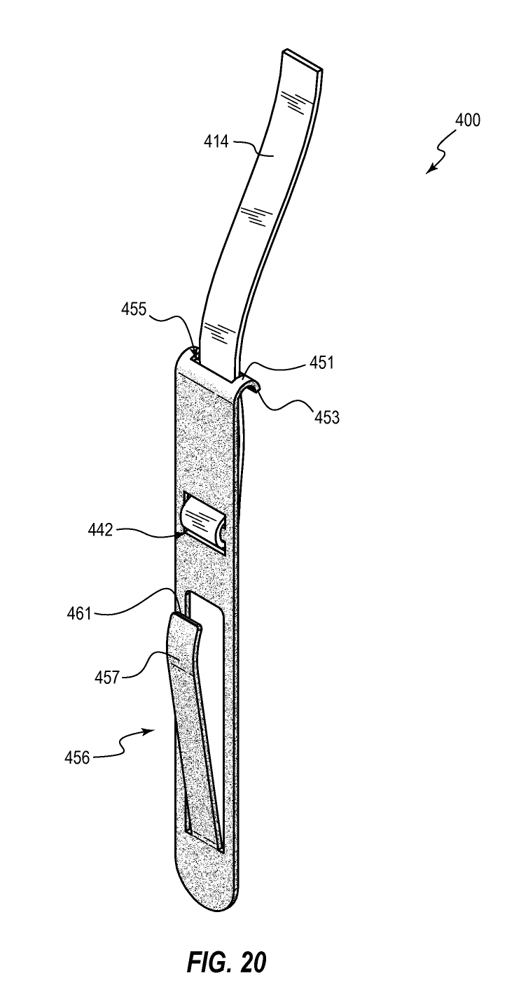

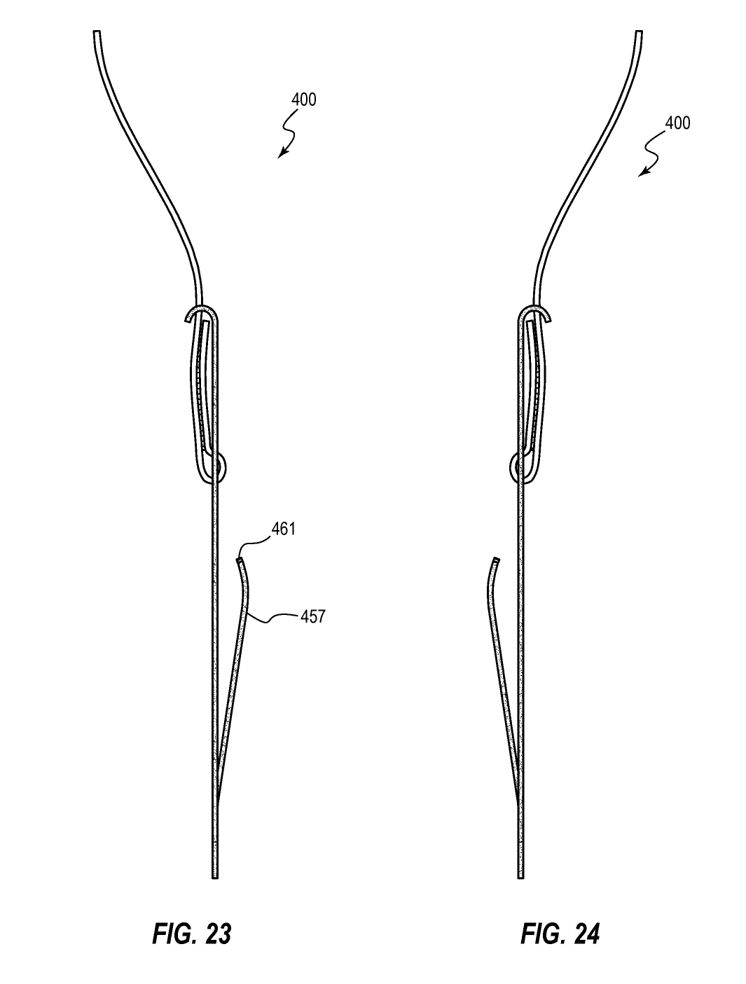

FIGS. 20-26 illustrate another embodiment of a bookmark 400. The bookmark 400 can resemble the bookmarks described above in many respects, but can differ in other respects. For example, in comparison to the bookmark 300, the bookmark 400 may include only two ribbon openings 442. The bookmark 400 can include a biasing member 456, which includes a stabilizing projection 457. Unlike the stabilizing projection 357, the stabilizing projection 457 can include a free end 461. In the illustrated embodiment, the free end 461 is at the upper end of the stabilizing projection 457. In some embodiments, the free end 461 can provide the stabilizing projection 457 with greater flexibility than a stabilizing projection 357 that is joined at both ends to a plate 311. As shown in FIG. 23, upper portion of the projection 457 can be curved rearwardly so as to inhibit the upper end 461 from catching on an outer cover 30 of a book 10 when the bookmark 400 is removed from the book 10. In some instances, situating the free end 461 at the top of the projection 457, rather than at the bottom thereof, can facilitate insertion of the bookmark 400 into the spine 32 of a book 10. In other embodiments, the free end 461 may be situated at the bottom of the projection 457.

The bookmark 400 can include a stop 451 and a contact edge 453. However, the stop 451 can include a slot 455 through which a ribbon 414 can extend. An upper end of the ribbon 414 can be free to move relative to the insert portion of the bookmark 400 through the slot 455, but the longitudinal movement of the ribbon 414 can be constrained by the slot. When the ribbon 414 extends through the slot 455, the contact edge 453 can directly contact the upper end of the binding region 34 of a book 10. In some embodiments, this can provide for a more secure contact between the stop 451 and the binding region 34.

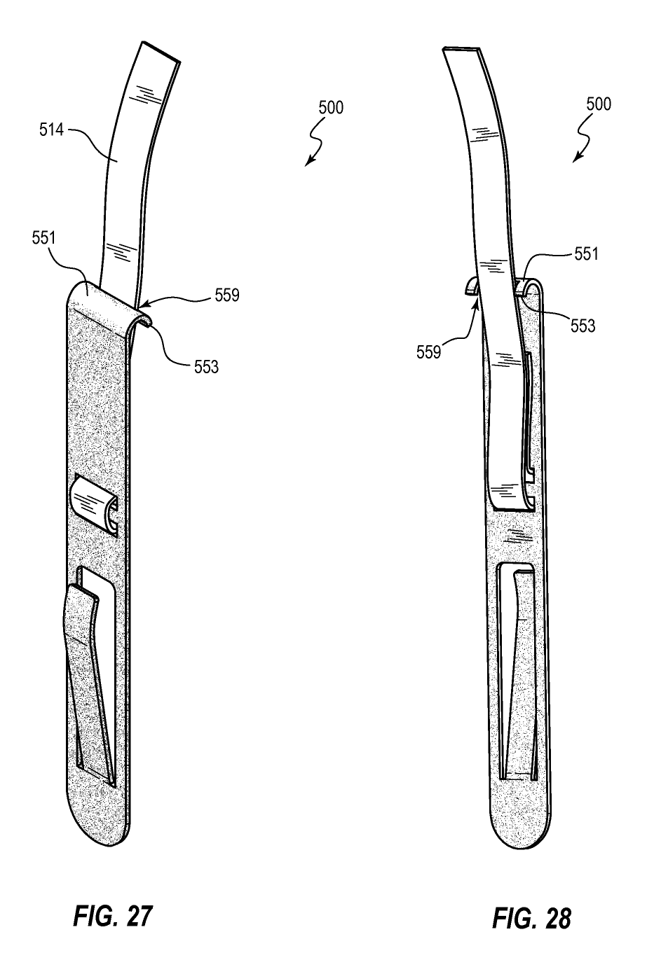

FIGS. 27 and 28 illustrate another embodiment of a bookmark 500. The bookmark 500 can resemble the bookmarks described above in many respects, but can differ in other respects. For example, the bookmark 500 may include a notch 559 in a stop 551 portion thereof. The notch 559 can extend forwardly from a contact edge 553 of the stop 551, and the contact edge 553 can extend to the right and to the left of the notch 559. A depth of the notch 559 can be greater than a thickness of a ribbon 514 of the bookmark 500. When the bookmark 500 is inserted in the spine 32 of a book 10, each portion of the contact edge 553 can contact the upper end of the binding region 34 of the book 10, and the ribbon 514 can extend outwardly through the notch 559.

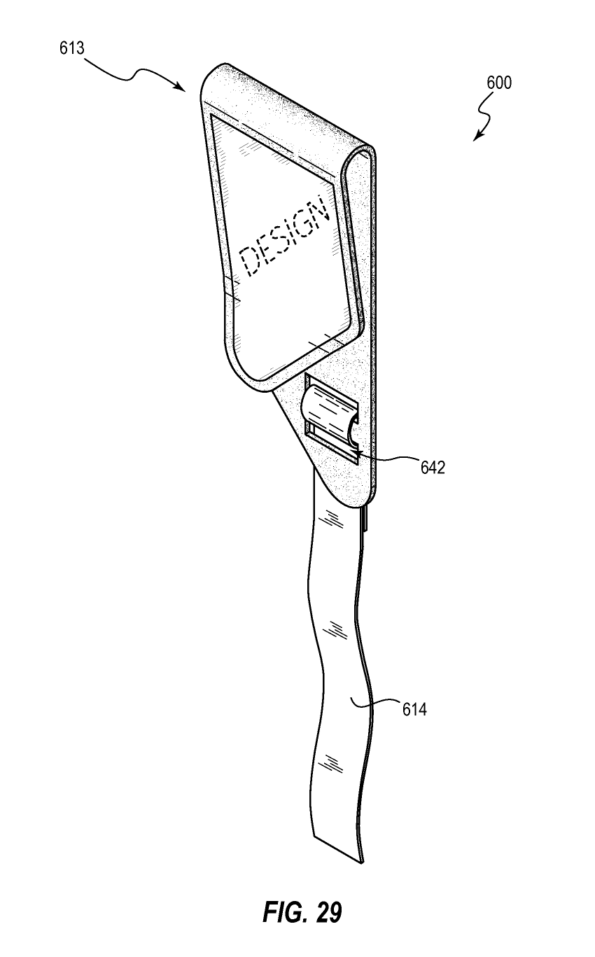

FIG. 29 illustrates another embodiment of a bookmark 600. The bookmark 600 can resemble other bookmarks described above in many respects, but can differ in other respects. For example, the bookmark 600 can particularly resemble the bookmark 200, and can include a ribbon 614 that extends through two openings 642 of a clip 613 so as to be attached to the clip 613. However, the bookmark 600 does not include a catch (such as the catch 230) at its upper end. Movement of the ribbon 614 thus is not constrained relative to an upper end of the clip 613.

The bookmark 600 may be said to have a single attachment region. The attachment region can include one or more openings through which the ribbon 614 passes so as to be attached to the clip 613. In the illustrated embodiment, the attachment region includes two openings 642 through which the ribbon 614 extends. The single attachment region can be at any suitable portion of the clip 613. In the illustrated embodiment, the attachment region is configured to be hidden from view when the clip 613 is attached to a cover flap of a book and the cover flap is closed. The attachment region is below a display body portion of the clip 613. In other embodiments, the single attachment region may be at a different position of the clip. For example, the attachment region may be higher than what is shown in FIG. 29. In some embodiments, the attachment region may be at a position at which the rigid body portion of the clip meets the display body portion of the clip —or, stated otherwise, at a clamping region of the clip. In other embodiments, the attachment region may be above the clamping region of the clip but below the upper end of the clip 613. In still other embodiments, the attachment region may be at the upper end of the clip 613. For example, in some embodiments, the attachment region may be positioned within a transition region that joins the rigid body portion of the clip 613 to the display body portion of the clip 613. In still further embodiments, the attachment region may be at an uppermost end of the clip 613.

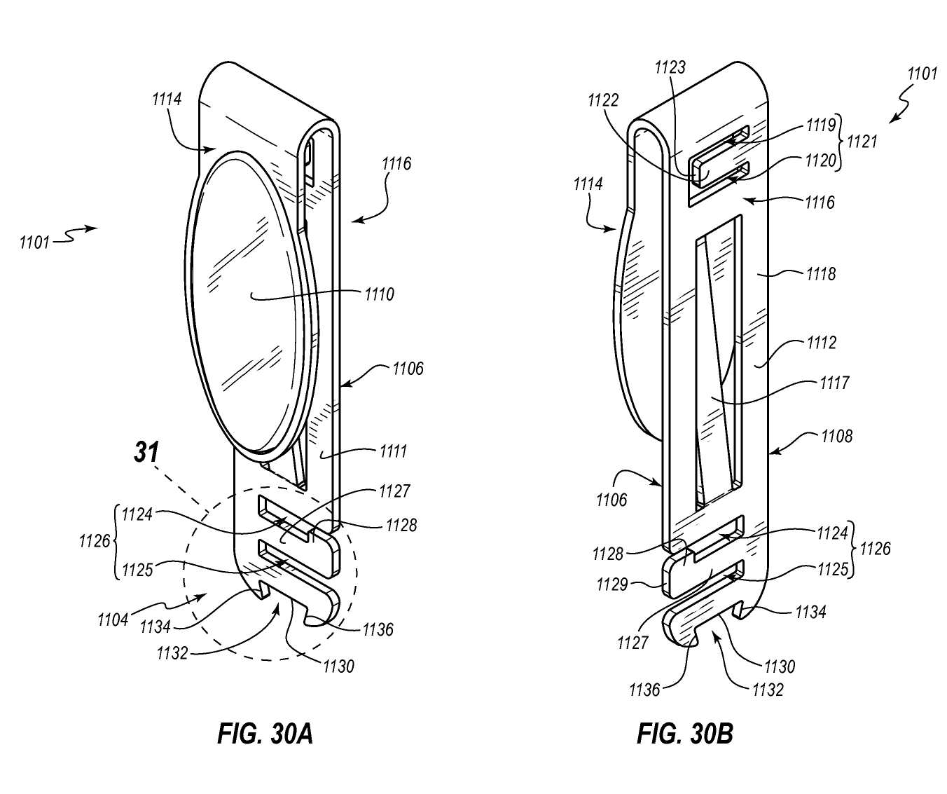

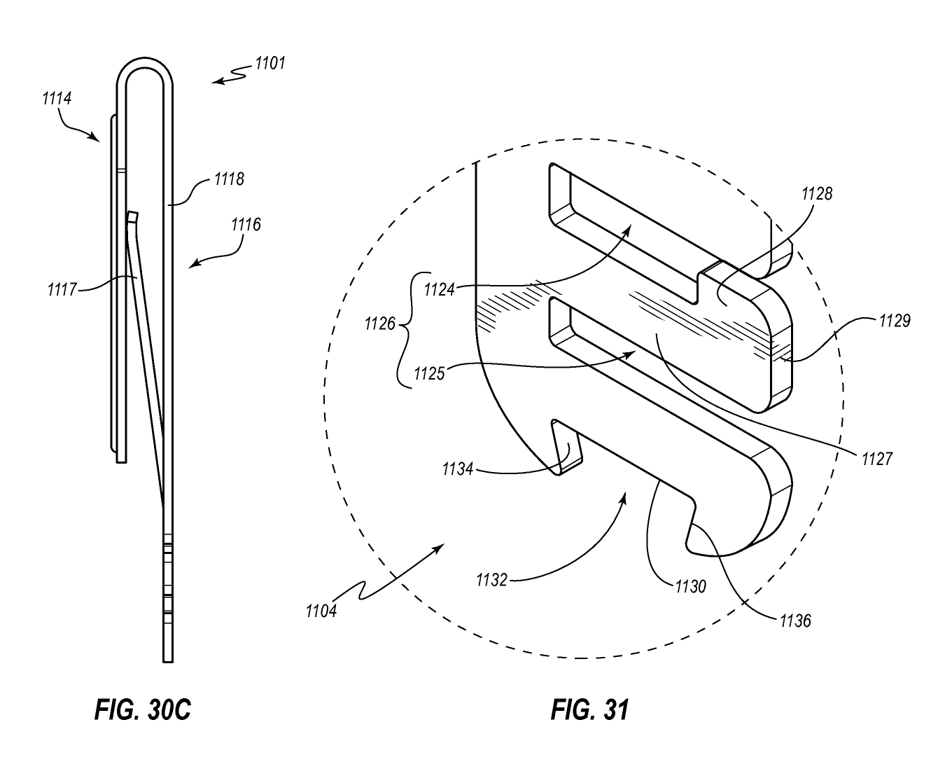

Further embodiments of bookmarks are depicted in FIGS. 30A-48G. Each of the embodiments can resemble various embodiments discussed above. Although some features of the following embodiments may be described with different terminology and/or numbering schemes than those used with respect to the embodiments depicted in FIGS. 1-29, it is apparent that like features may be present among the various embodiments of bookmarks depicted in FIGS. 1-29 and those depicted in FIGS. 30A-48G. Accordingly, terminology used in describing features of the foregoing embodiments of bookmarks applies equally to like features in the embodiments described hereafter. Similarly, terminology used in describing features of the following embodiments of bookmarks applies equally to like features in the embodiments described above. Any suitable combination of the features of the embodiments depicted in FIGS. 1-29 is possible, any suitable combination of the features of the embodiments depicted in FIGS. 30A-48G is possible, and any suitable combination of the features of the embodiments depicted in FIGS. 1-29 with the features of the embodiments depicted in FIGS. 30A-48G is possible.

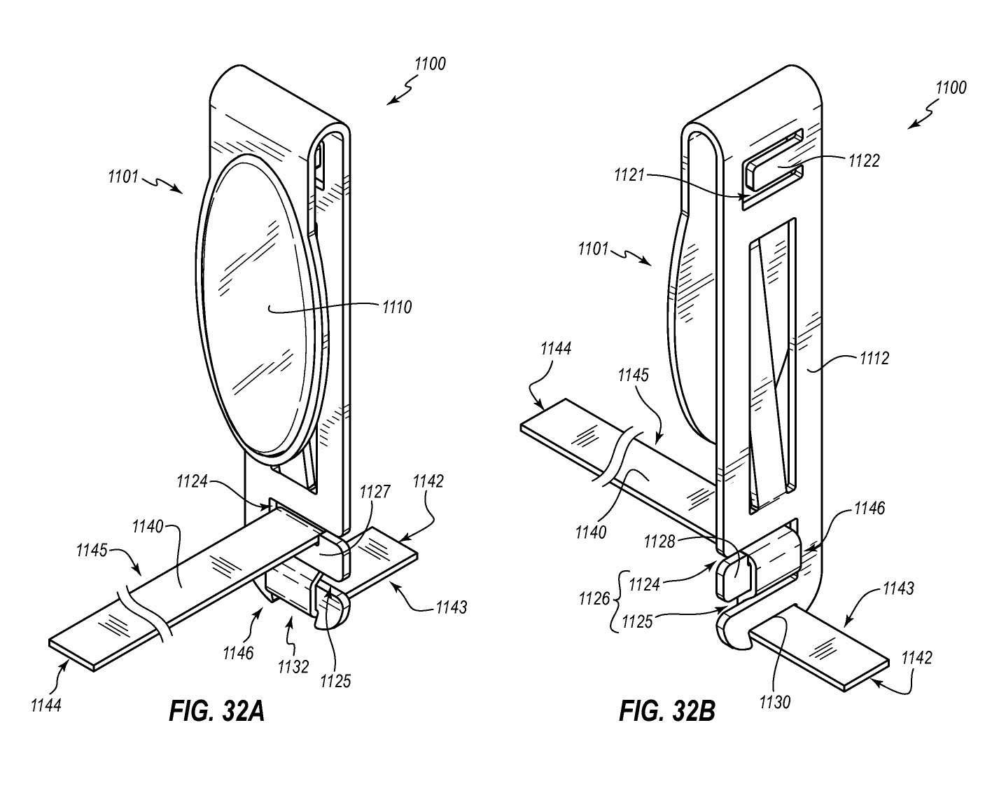

FIGS. 30A-35 illustrate an embodiment of a bookmark 1100 that includes a base 1101 (see, e.g., FIGS. 30A and 30B) and a ribbon 1140 (see, e.g., FIGS. 32A and 32B). Details of the base 1100 are discussed with respect to FIGS. 30A-31, and various stages of a method for attaching the ribbon 1140 to the base 1101 are discussed with respect to FIGS. 32A-34B. A manner in which an illustrative example of an assembled bookmark 1100 can be coupled with a book 10 is discussed with respect to FIG. 35. In the following discussion, directional terms are used in their ordinary sense when the bookmark 1100 is oriented as it normally would be when coupled to a book (e.g., the book 10) and viewed from an exterior of the book, and these directional terms are consistent with those discussed above with respect to the arrows 40, 42, 44, and 46 of FIG. 1. For example, in FIG. 35, the “front” portion of the bookmark 1100 is visible, whereas a “rear” portion of the bookmark is inserted in a spine portion 32 of the book 10 and is hidden from view. An upper end of the bookmark 1100 is at a top edge of the book 10. Although innovative features may be present with respect to the specific orientations thus described, such directional terms and orientations are not necessarily limiting with respect to the design or use of some bookmarks 1100. For example, in some cases, a bookmark 1100 may be inserted into the spine 32 of the book 10 at a lower end of the book 10, such that the “upper end” of the bookmark 1100 may be at a lower edge of the book 10 when in use.

With reference to FIGS. 30A and 30B, the base 1101 defines an upper end 1102, a lower end 1104, a front face 1110, and a rear face 1112. The base 1101 includes a display body 1114 that is coupled with a rigid body 1116. The display body 1114 can be configured for viewing once the bookmark 1100 is coupled with the book 10 (see FIG. 35). Accordingly, in some embodiments, the display body 1114 may bear a design, decoration, or other feature having aesthetic, artistic, or other appeal. The design or other such feature may, for example, be included on a plate, sticker, or other item that is initially separate from the display body 1114 and is attached to the display body 1114 in any suitable fashion (e.g., adhesives or welding), be directly applied to the display body 1114 (e.g., painted on), or be integral to or removed from the display body 1114 (e.g., raised features, stamped features, cutouts, or etchings).

In the illustrated embodiment, the display body 1114 and the rigid body 1116 are integrally formed with each other and are connected via a rounded or curved region at the upper end 1102 of the base 1101. The rigid body 1116 extends longitudinally between the upper and lower ends 1102, 1104 of the base 1101. The rigid body 1116 further extends laterally between a left edge 1108 and a right edge 1106. The rigid body 1116 may be formed of any suitable material, and may be configured to be positioned within a spine of a book or otherwise be positioned behind the cover of a book. The term “rigid” is not intended to be limiting, and can include substantially rigid or semi-rigid materials that are able to substantially maintain their form under minor stresses and/or readily remove to an initial state after minor deformations. For example, in various embodiments, the rigid body 1116 (and/or other portions of the base 1101) may be formed of a metal or plastic.

The rigid body 1116 can include a spring member 1117 that projects forwardly from a rear portion 1118 of the rigid body 1116. The spring member 1117 thus can extend toward a rearward side of the display body 1114. The spring member 1117 can be resiliently deformable, such that a biasing force may arise within the spring member 1117 upon displacement thereof relative to the rear portion 1118 of the rigid body 1116. The spring member 1117 can be configured to provide a biasing force in a forward direction when a portion of a cover 30 of the book 10 is inserted between the rigid body 1116 and the display body 1114 so as to compress the spring member 1117, as discussed further below with respect to FIG. 35. In the illustrated embodiment, and as is common for many varieties of books, the cover 30 of the book 10 can include both a front and a back cover flap 20, 22. Moreover, the cover 30 can extend between the front cover flap 20 to the back cover flap 22 so as to define an outer portion of a spine 32 of the book 10.

The base 1101 can be configured to couple with the ribbon 1140, as discussed further with respect to FIGS. 13A-5B. With continued reference to FIGS. 11A-1B, the rigid body 1116 portion of the base 1101 may include a number of elongate protrusions, anchor members, lateral projections, tabs, grips, bars, or shelf members 1122, 1127 about which the ribbon 1140 may be threaded or otherwise positioned or secured. Each shelf member 1122, 1127 may respectively be bordered by one or more openings 1119, 1120, 1121, 1124, 1125, 1126 through which the ribbon 1140 may pass to facilitate the coupling of the ribbon 1140 to the base 1101.

In the illustrated embodiment, a first shelf member 1122 is positioned at or near the upper end 1102 of the base 1101. An opening 1121 extends about three sides of the first shelf member 1122. The opening 1121 includes a first opening 1119 that borders an upper side of the shelf member 1122 and a second opening 1120 that borders a lower side of the shelf member. The opening 1121 further proceeds about a free end 1123 of the shelf member 1122. It may be said that the shelf member 1122 is disposed within the opening 1121. The shelf member 1122 may extend laterally across a portion of the rigid body 1116. In the illustrated embodiment, the shelf member 1122 extends laterally from left to right, but it is understood that the shelf member 1122 can extend laterally from right to left in other embodiments. The shelf member 1122 can be flush with surrounding portions of the rigid body 1116. For example, in the illustrated embodiment, the rear face 1112 of the rigid body 1116 is substantially planar, and a rear face of the shelf member 1122 may be in the same plane as the rear face 1112 of surrounding portions of the base 1101. The shelf member 1122 may be formed from the same material as the rigid body 1116 of the bookmark. For example, in some embodiments, the opening 1121 may comprise a stamped- or punched-out, etched, or other such region at which a portion of the material of which the shelf member 1122 and the rigid body 1116 are formed has been removed.

Another shelf member 1127 can be positioned at the lower end 1104 of the rigid body 1116. The shelf member 1127 can be in the same plane as the rear portion 1116 of the body and can be disposed laterally along the body. In the illustrated embodiment, the shelf member 1127 is disposed in a lower opening 1126 of the rigid body 1116. The illustrated shelf member 1127 extends from left to right in the lateral direction. As with the shelf member 1122, the shelf member 1127 can also be disposed from right to left in the lateral direction, in other embodiments. Moreover, the shelf member 1122 and the shelf member 1127 may extend in the same direction laterally (i.e. both from left to right, as illustrated, or both from right to left) or in opposite lateral directions (i.e. one from left to right and the other from right to left). Further, the shelf member 1127 may be disposed substantially parallel to the shelf member 1122. As further discussed below, in other embodiments, one or more of the upper and lower shelf members 1122, 1127 can be closed at both lateral ends thereof, or stated otherwise, can be joined with surrounding portions of which the rigid body 1116 is formed at both lateral ends thereof. For example, one or more of the shelf members 1122, 1127 can be configured in the same manner as the holding bar 144 discussed above (see FIGS. 2-4, 9, and 10).

As illustrated in FIGS. 30A and 30B the upper opening 1121 fully extends about three sides of the shelf member 1122. In contrast, the lower opening 1126 extends about only two sides of the shelf member 1127. In particular, the lower opening 1126 includes a first opening 1124 that borders an upper side of the shelf member 1127 and includes a second opening 1125 that borders a lower side of the shelf member 1127. Accordingly, a free end 1129 of the shelf member 1127 is not bordered by the opening 1126 that is defined in the rigid member 1116. Rather, the free end 1129 is substantially flush with the right edge 1106 of the rigid member 1116.

Stated otherwise, the upper opening 1121 is fully enclosed, encircled, or encompassed by the rigid member 1116. Likewise, the free end 1123 of the upper shelf member 1122 is fully enclosed, encircled, or encompassed by neighboring portions of the rigid member 1116. In contrast, the lower opening 1126 and the lower shelf member 1127 are not fully encompassed by neighboring portions of the rigid member 1116, such that the lower shelf member 1127 is directly accessible from the right side of the rigid body 1116.

It will be appreciated that the upper opening 1120 could extend completely to one edge of the rigid body 1116 (as the lower opening 1126 does). In other or further embodiments, the lower opening 1126 could be completely enclosed (as the upper opening 1121 is). Where a free end 1123, 1129 is exposed (such as the free end 1129 in the illustrated embodiment), it should be understood that the free end 1123, 1129 could be at either side of the rigid body 1116. The terms “distal” and “proximal” may be used herein to refer to portions of the upper and lower shelf members 1122, 1127. As used herein, the term proximal refers to the end of the shelf member 1122, 1127 that is coupled to the rigid body 1116, and the distal end comprises the free ends 1123, 1129 of the shelf members 1122, 1127, respectively. It may be said that the shelf members 1122, 1127 project from an interior portion of the rigid body 1116 and terminate at the free ends 1123, 1129, or stated otherwise, project from the rigid body 1116 in a distal direction.

With reference to FIG. 31, which is a detail front perspective view of the lower edge of the bookmark of FIG. 11A, the shelf member 1127 includes a retaining shoulder 1128 located at its distal end. The retaining shoulder 1128 is configured to restrain lateral movement of the ribbon 1140 after it has been looped around the shelf member 1127. In various embodiments, one, both, or neither of the shelf members 1122, 1127 can include a retaining shoulder.

With continued reference to FIG. 31, the rigid body 1116 can include a notch 1130 positioned in its lower end 1104. The notch 1130 can define a recess 1132 that is sized and shaped to receive a portion of the ribbon 1140 therein and to restrain lateral movement of the ribbon 1140. The notch 1130 can include angled sidewalls 1134, 1136 that may assist in maintaining the ribbon 1140 within the recess 1132. For example, in the illustrated embodiment, the sidewalls 1134, 1136 angle inwardly in a downward direction such that greater space within the recess 1132 is available at an upper end of the recess 1132 than at a lower end thereof. In other embodiments, the sidewalls 1134, 1136 may be substantially parallel to each other, or may angle outwardly in a downward direction.

The shelf members 1122, 1127, the openings 1121, 1126, and the notch 1130 may be utilized in coupling a ribbon 1140 to the base 1101. Although an adhesive may optionally be used in coupling the ribbon 1140 to the base 1101, the foregoing structures may cooperate such that the coupling can occur without the use of adhesive or any other supplemental securing mechanism (e.g., staples, clips, etc.). Where an adhesive is used, the ribbon 1140 could be adhered to the base 1101 directly via the adhesive, or it may be looped around a portion of the base 1101 and then attached to itself via the adhesive. In situations where no adhesive is used, such as those discussed below with respect to certain illustrative methods, the ribbon 1140 may be threaded through and around, or otherwise advanced about, the shelf members 1122, 1127 in such a manner as to hold the ribbon 1140 in place via friction. Such frictional engagement or frictional attachment may be completed in such a manner as to maintain the ribbon substantially flat along its length. Such flattened arrangements can allow for a more compact or lower profile design than other possible arrangements, such as arrangements in which a knot may be tied in the ribbon 1140 so as to secure the ribbon to the base 1101.

FIGS. 32A to 34B depict various stages of an illustrative method for coupling the ribbon 1140 to the base 1101. It will be understood that other suitable methods also exist for coupling the ribbon 1140 to the base 1101 such that the ribbon 1140 is maintained in place through frictional engagement.

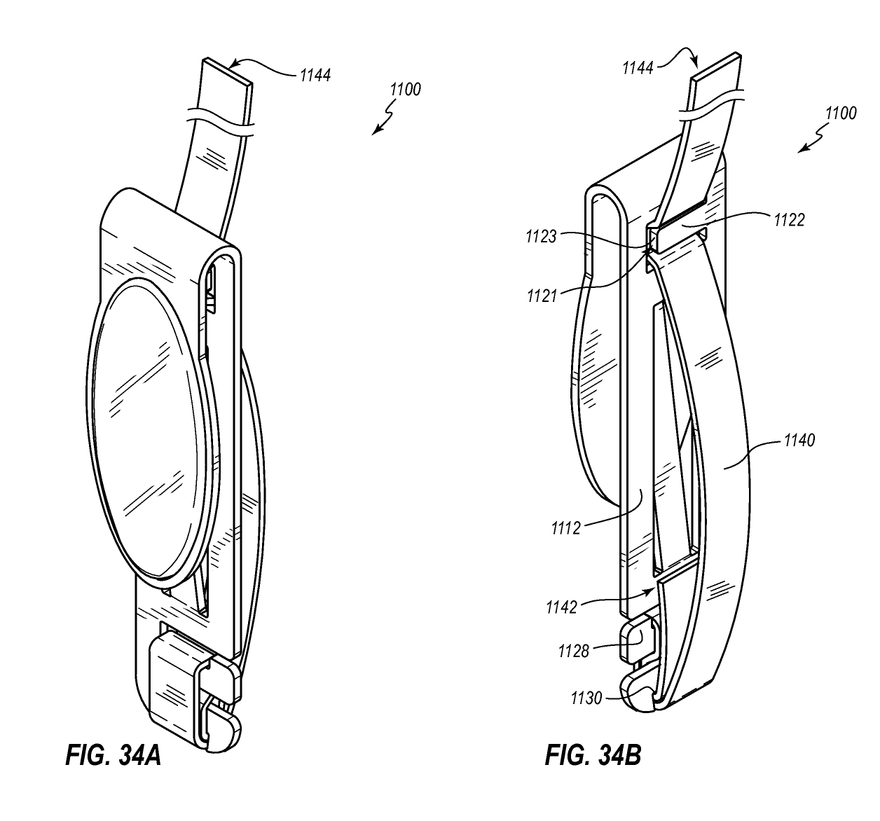

FIGS. 32A and 32B illustrate an early stage of coupling the ribbon 1140 to the base 1101. The ribbon 1140 has a proximal end 1142 and a distal end 1144. In the illustrated method, the proximal end 1142 of the ribbon 1140 is the end that is closest to the base 1101 when the ribbon 1140 is completely coupled to the base 1101 (see FIG. 34B), whereas the distal end 1144 is the free end that extends away from the base 1101 and may be used as a placeholder in the book 10 (see FIG. 35). It should be understood, however, that such terminology is used for convenience in describing the present example, but is not limiting. For example, as discussed below, in some embodiments, once the ribbon 1140 has been coupled with the base 1101, the proximal end 1142 also extends away from the base 1101, such that each of the proximal end 1142 and the distal end 1144 of the ribbon 1140 may be used as placeholders in the book 10.

The ribbon 1140 can include an intermediate segment 1146 that is at any suitable position between the proximal and distal ends 1142, 1144. Depending on the methodology used for coupling the ribbon 1140 to the base, the intermediate segment 1146 may be closer to one of the ends 1142, 1144 than the other, or may be spaced substantially equally from each end 1142, 1144. The intermediate segment 1146 includes the portion of the ribbon 1140 that interacts with the lower shelf member 1127, which can assist in maintaining the ribbon 1140 in a secure attachment to the base 1101.

With continued reference to FIGS. 32A and 32B, in an early stage of coupling, the proximal end 1142 of the ribbon may be threaded in a rearward direction through the opening 1124 that is above the shelf member 1127. The proximal end 1142 of the ribbon 1140 may then be doubled back and threaded in a forward direction through the opening 1125 that is below the shelf member 1127 so as to bring the intermediate segment 1146 of the ribbon 1140 into contact with the lower shelf member 1127. The proximal end 1142 of the ribbon 1140 may then be wrapped about the lower end 1104 of the base 1101 in a rearward direction so that a portion of the ribbon 1140 is received within the recess 1132 of the notch 1130.

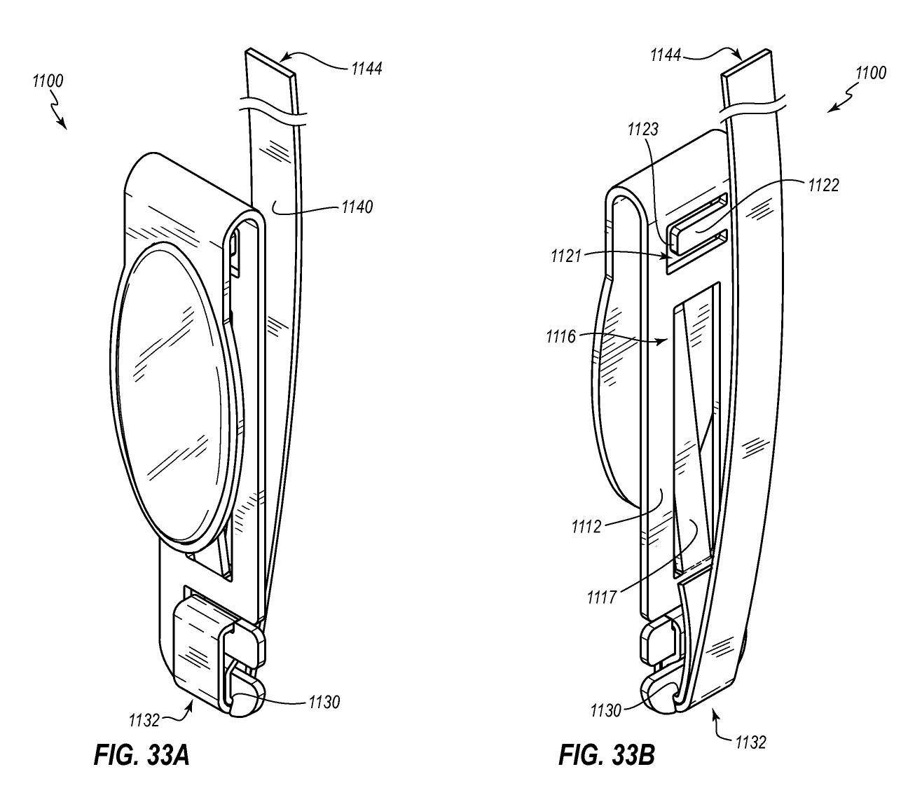

With reference to FIGS. 33A and 33B, in another stage of coupling the ribbon 1140 to the base 1101, the proximal end 1142 of the ribbon 1142 is disposed against the back face 1112 of the rigid body 1116. A proximal length of the ribbon 1142 (e.g., a portion of the ribbon 1140 that is between the intermediate segment 1146 and the proximal end 1142) thus may extend along the back face 1112 in a longitudinal direction from the lower end 1104 toward the upper end 1102. In some arrangements, the proximal end 1142 of the ribbon 1140 may only extend partially along a the length of the rigid body 1116. For example, in the illustrated embodiment, the proximal end 1142 of the ribbon 1140 is positioned at a bottom end of the spring member 1117 (see FIG. 33B).

With continued reference to FIGS. 33A and 33B, the distal end 1144 of the ribbon 1140 may also be wrapped about the lower end 1104 of the base 1101 in a rearward direction so as to be received within the recess 1132 of the notch 1130. The distal end 1144 likewise can extend along the back face 1112 of the base 1101, as discussed further below.

With reference to FIGS. 34A and 34B, in another stage of coupling the ribbon 1140 to the base 1101, the distal portion of the ribbon 1140 may be inserted into the opening 1121 so as to engage the ribbon 1140 with the upper shelf member 1122. In some instances, the distal end 1144 of the ribbon 1140 may be threaded into the portion of the opening 1121 that is below the shelf member 1122 and then threaded back out through the portion of the opening 1121 that is above upper shelf member 1122. In other instances, the ribbon 1140 is forced into the portion of the opening 1121 that borders the free end 1123 of the upper shelf member 1122. For example, a side edge of the ribbon 1140 may be inserted into the opening 1121, and the ribbon 1140 may be advanced in a lateral direction into the position depicted in FIG. 34B in which ribbon 1140 is frictionally engaged with upper and lower front edges of the upper shelf member 1122.

In some instances, after the ribbon 1140 has been positioned in the opening 1121 about the upper shelf member 1122 (e.g., after having been brought to the orientation shown in FIG. 34B), the distal end 1144 of the ribbon 1140 may be pulled taut so as to remove slack from the ribbon 1140 and thus bring the upper portion of the ribbon 1140 into close proximity to the rear face 1112 of the base 1101. In such a configuration, friction between surfaces of the ribbon 1140 that are in contact with the base 1101 and between surfaces of the ribbon 1140 that are in contact with each other may secure the ribbon 1140 to the base 1101 in a substantially secure fashion. Moreover, the retaining shoulder 1128 and the notch 1130 may restrain the ribbon 1140 so as to inhibit or prevent lateral displacement. Restraining movement of the ribbon 1140 in this manner can serve to maintaining contact between the ribbon 1140 and the base 1101 and between adjacent portions of the ribbon 1140 so as to maintain sufficient frictional forces to keep the ribbon 1140 secured to the base 1101.

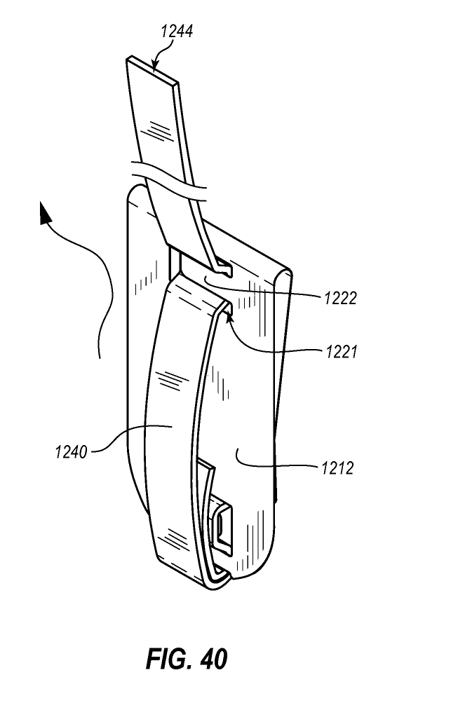

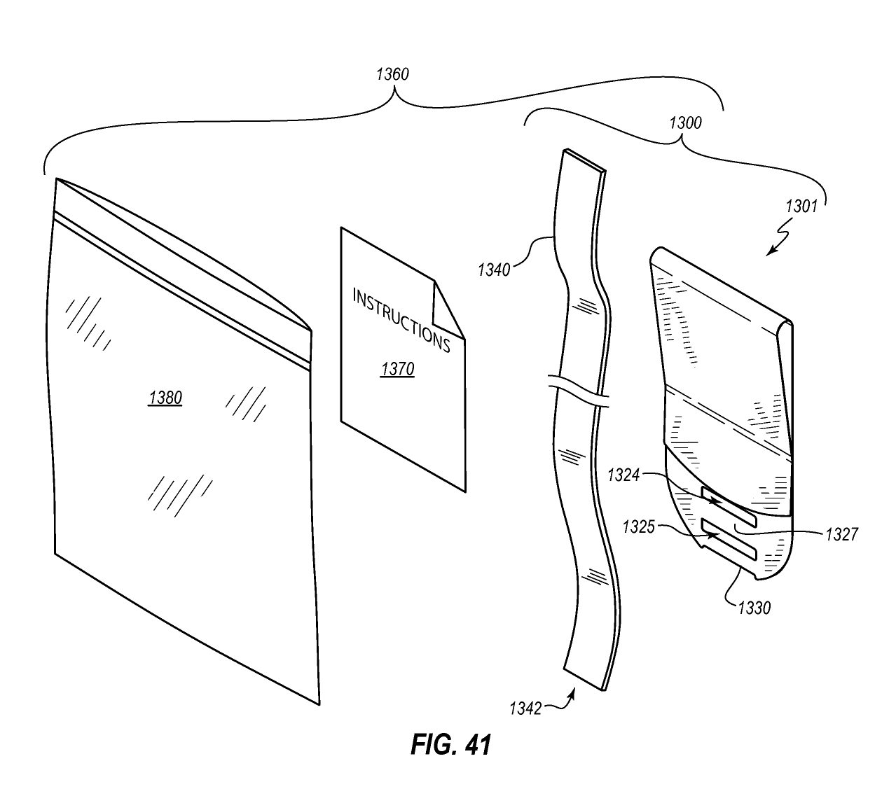

It will be appreciated that certain procedures described above may be achieved in embodiments where the shelf member extends completely across the opening, such that the shelf does not include a free end, whether such free end is directly accessible from a side of the rigid body 1116 (e.g., such as the free end 1129) or is accessible from a rear of the rigid body 1116 (e.g., such as the free end 1123). Another example of such a shelf member arrangement is shown in FIG. 41. In other words, in some embodiments, the shelf member may extend from the rigid body 1116 at either end thereof, and openings above and below the shelf member can each be fully enclosed (e.g., have four sides). In particular, “threading” procedures described above can be used with shelf members that have a free end (e.g., a three-sided geometry) as well as those that do not (e.g., a two-sided open geometry).

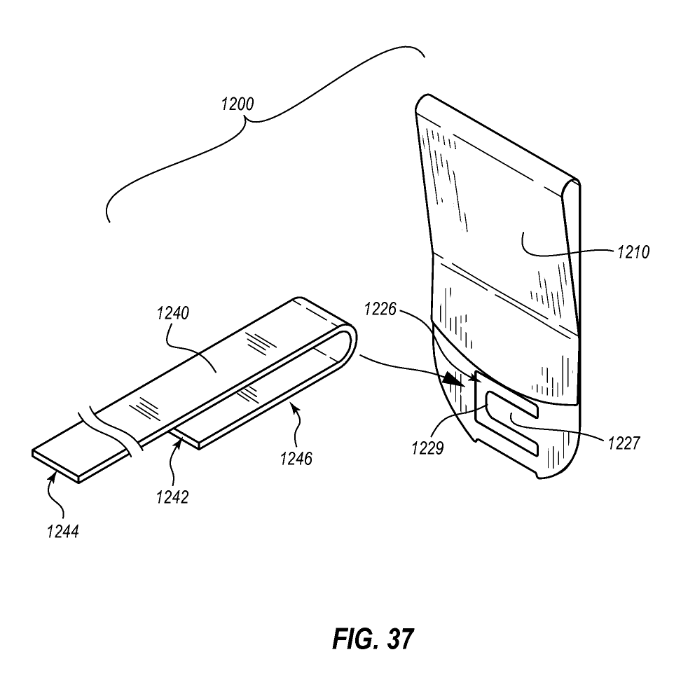

It is further noted that other methods of assembling the bookmark 1100 are also possible. Specifically, with reference to FIGS. 32A and 32B, a different procedure may be used to insert the ribbon 1140 over the shelf member 1127. Given the direct accessibility of the shelf member 1127 from the right side of the rigid body 1116, the ribbon 1140 may not be “threaded” through the openings that boarder the shelf member 1127. Rather, the ribbon may instead be looped, and then the looped portion of the ribbon 1140 may be advanced laterally over the shelf member 1127 in the right-to-left direction. Such a technique will be further appreciated in view of the discussion below with respect to FIG. 37.

Moreover, with reference to FIGS. 32A-33B, it is possible to wrap both the proximal and distal portions of the ribbon 1140 about the lower end 1104 of the rigid body 1116 simultaneously, rather than in separate stages as shown in these drawings. In other or further embodiments, both proximal and distal portions of the ribbon 1140 are inserted into the upper opening 1121 so as to be retained by the upper shelf member 1122. Accordingly, both the proximal end 1142 and the distal end 1144 of the ribbon 1140 can extend away from the base 1101, such that both the proximal end 1142 and the distal end 1144 of the ribbon 1140 may be used as placeholders in the book 10. It will be understood that other suitable coupling procedures and arrangements are also possible.

FIG. 35 shows a bookmark base 1101 coupled to a ribbon 1140 and further coupled to a book 10. The bookmark base 1101 may be coupled to the spine 32 of the book 10, as illustrated, or it may be attached to other regions of the book 10 (such as the front cover flap 20). In the illustrated configuration, the ribbon 1140 can be selectively draped over any desired number of the pages of the book 10 and extended between adjacent pages so as to serve as a placeholder. The display body 1114 is at an exterior of the cover 30 of the book 10, and the rigid body 1116 is at an interior of the cover 30 of the book 10. The cover 30 thus extends between the display body 1114 and the rigid body 1116 so as to compress the spring member 1117, which can assist in maintaining the base portion 1101 of the bookmark 1100 secured to the cover 30.

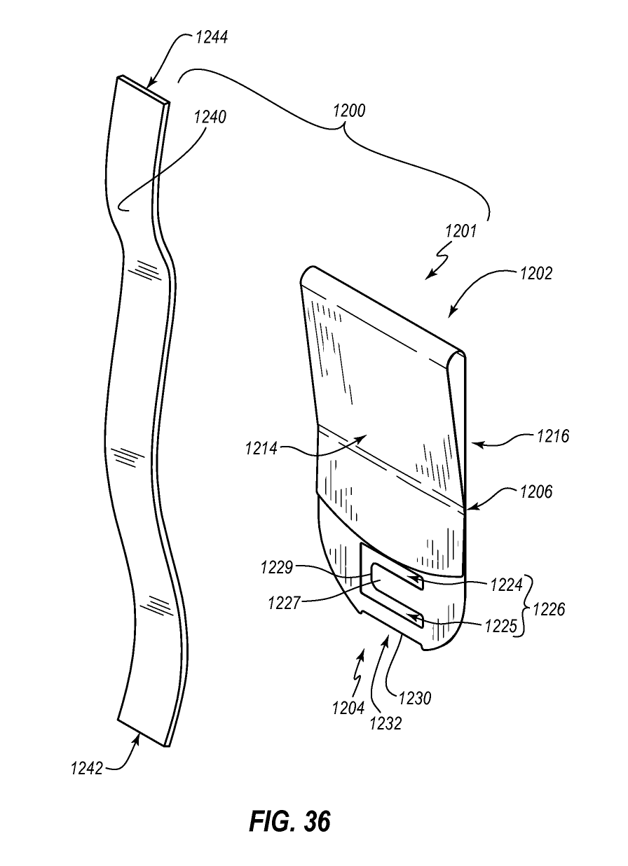

FIGS. 36-40 illustrate another embodiment of a bookmark 1200, which can resemble the bookmark 1100 described above in certain respects. With reference to FIG. 36, the bookmark 1200 includes a base 1201 and a ribbon 1240. The base 1201 includes a display body 1214 and a rigid body 1216. As with the display body 1114, the display body 1214 can be configured to be positioned at an exterior of a book 10 when the bookmark 1200 is coupled thereto such that the display body 1214 is viewable. The display body 1214 thus may bear a design, decoration, or other feature. The rigid body 1216 can be coupled with the display body 1214 and can be configured to cooperate therewith to maintain the bookmark 1200 coupled with a book 10. The manner in which the rigid body 1216 and the display body 1214 cooperate with each other can vary from the cooperation between the rigid body 1116 and the display body 1114 discussed above.

As with the rigid body 1116 and the display body 1114, the rigid body 1216 and the display body 1214 can be connected to each other by an extension at an upper end 1202 of the base 1201. The extension is rounded in the illustrated embodiment, but other configurations are also possible. The rounded extension can act as a spring such that a lower portion of the display body 1214 is biased rearwardly toward the rigid body 1216. The display body 1214 and the rigid body 1216 thus can act as a clip.

The rigid body 1216 can be semi-rigid or substantially rigid, as discussed with respect to the rigid body 1216. The rigid body 1216 likewise may be elongated between the upper end 1202 and a lower end 1204 of the base 1201. The rigid body 1216 may be wider, relative to the display body 1214, than is the rigid body 1116 relative to the display body 1114. In some arrangements, the rigid body 1216 may be wider than a thickness of a book 10, such that the rigid body 1216 may not be practicable for use with the binding of the book 10, and may instead be positioned behind a flap or cover (front or back) of the book 10.

In the illustrated embodiment, the rigid body 1216 of the base 1201 includes a lower opening 1226 and a shelf member 1227. An upper portion 1224 of the lower opening 1226 is at an upper edge of the shelf member 1227 and a lower portion 1225 of the opening 1226 is at a lower edge of the shelf member 1227. Whereas the lower opening 1126 of the base 1101 described above extends completely to one side of the base 1101, the lower opening 1226 of the base 1201 extends only partially across a width of the rigid body 1216. Thus, the lower opening 1226 is completely enclosed, surrounded, encircled, or encompassed by neighboring portions of the rigid body 1216. It will be appreciated that the rigid body 1216 could instead include an opening that extends completely to one side of rigid body 1216 (as in FIG. 30A). Similarly, the rigid body 1116 described above could instead include an opening and shelf member such the opening 1226 and the shelf member 1227.

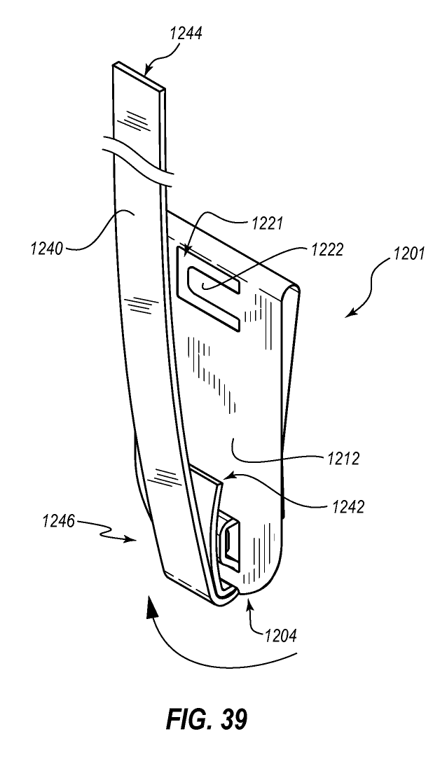

As shown in FIG. 39, the rigid body 1216 can include an upper opening 1221 and an upper shelf member 1222, which can resemble the upper opening 1121 and the upper shelf member 1122 described above. It is noted that the upper openings 1121, 1221 and associated upper shelf members 1122, 1222 can be of a form other than that shown in FIGS. 30B and 39, respectively. For example, in some embodiments, the upper openings 1121 and shelf members 1122, 1222 can resemble the lower opening 1126 and the lower shelf member 1127 described above with respect to the base 1101.

With continued reference to FIG. 36, the base 1201 includes a notch 1230 at a lower end 1204 thereof. As explained above, features of the bookmark 1200 may be interchangeable with the bookmark 1100 depicted above. For instance, the notch 1130 of the bookmark base 1101 is illustrated as having a greater depth than the notch 1230 of bookmark base 1201. Either configuration of the notch 1130, 1230 design may be compatible with either bookmark 1100, 1200, and other suitable arrangements are also possible. In the illustrated embodiment, the notch 1230 widens in a downward direction.

FIG. 37 illustrates an early stage of coupling the ribbon 1240 to the base 1201. As illustrated, a proximal portion of the ribbon 1240 may be doubled back on itself prior to its coupling with the base 1201. An intermediate segment 1246 of the ribbon 1140, which is coupled with the lower shelf member 1227, can comprise the doubled back portion. In some embodiments, the doubled back portion defines a loop. In FIG. 37, the looped end is shown in an open state, but the loop could be arranged in a closed state. For example, a user may hold both ends of the doubled back portion of the ribbon 1240 between a thumb and a finger, such that both portions of the ribbon 1240 contact each other and such that the ribbon 1240 defines an opening into which the shelf member 1227 can be received. The loop can be advanced over the shelf member 1227. An edge of the loop can be advanced over a free end 1229 of the shelf member 1227 and into the opening 1226, as depicted by a bold arrow in FIG. 37.

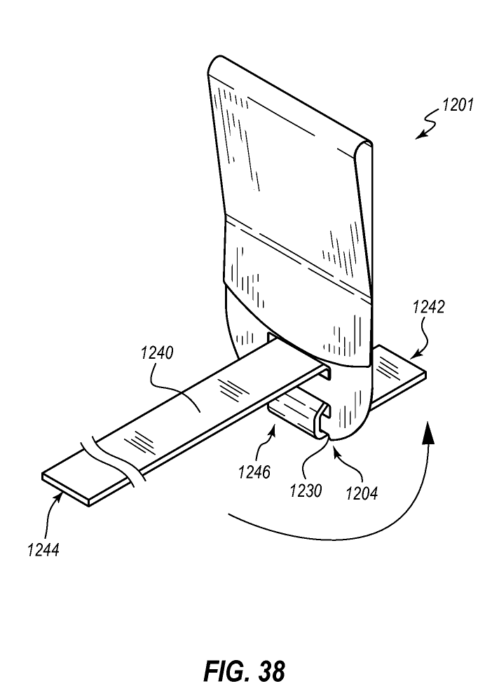

FIG. 38 illustrates another stage of coupling the ribbon 1240 to the base 1201. The proximal end 1242 of the ribbon 1240 may be wrapped about or otherwise disposed around the lower end of the body 1201 so as to be received in the notch 1230, as depicted by a bold arrow.

FIG. 39 illustrates another stage of coupling the ribbon 1204 to the base 1201. The proximal end 1242 of the ribbon may be disposed against a back face 1212 of the base 1201 so as to extend upwardly in a longitudinal direction along the back of the base 1201. The distal end 1244 of the ribbon 1240 may also be wrapped about the bottom end 1204 of the base 1201 and may be brought into close proximity to the rear face 1212 of the base 1201. As described above with respect to the bookmark 1100, in some instances, the proximal and distal ends 1242, 1244 of the ribbon 1240 can be wrapped about the bottom end of the base 1201 simultaneously, rather than separately as shown in FIGS. 38 and 39.

FIG. 40 illustrates another stage of coupling the ribbon 1204 to the base 1201. In some embodiments, a distal portion of the ribbon 1240 is advanced into a position about shelf member 1222 in a manner similar to that discussed above with respect to insertion of the ribbon 1240 about the shelf member 1226. For example, in some embodiments, a loop may be formed from the ribbon 1240 and an edge of the ribbon 1240 may be advanced into the opening 1221. In other instances, the edge of the ribbon 1240 may be inserted into the opening 1221 without first forming a loop in the ribbon 1240. In still other methods, the distal end 1244 of the ribbon may be threaded into the upper opening 1221 below the shelf member 1222 in a forward direction, then back through the upper opening 1221 above the shelf member 1222 in a rearward direction. After insertion of the ribbon 1240 into the opening 1221, the distal end 1244 of the ribbon 1240 may be pulled tight to remove slack in the ribbon 1240, which can assist in maintaining tension or friction in the ribbon 1240 at the lower end of the base 1201.

FIG. 41 illustrates that an embodiment of a kit 1360 that can include various components of a bookmark 1300 that may come in a pre-assembled state or in a separated state. The kit 1360 can include a base 1301 and one or more ribbons 1340. Any suitable base and ribbon may be present in the kit 1360, such as any of those discussed above. In the illustrated embodiment, the base 1301 includes a shelf member 1327 that is different from other shelf members described above. In particular, the shelf member 1327 is enclosed, circumscribed, or surrounded at either end thereof by the base 1301. Stated otherwise, the shelf member 1327 extends from an interior portion of the base 1301 and terminates at another interior portion of the base 1301. It is noted that the shelf member 1327 is positioned in a rigid body portion of the base 1301.

A first opening 1324 can be positioned above the shelf member 1327, and a second opening 1325 can be positioned below the shelf member 1327. Such an arrangement can be suitable for threading of a proximal end 1342 of the ribbon 1340 about the shelf member 1327 in manners such as described above, as the shelf member 1327 is accessible from the front and rear sides of the base 1301, but is not directly accessible from either side edge of the base 1301.

The kit 1360 can further include instructions 1370, which may be contained on a separate sheet or card within a packet or package 1380 (e.g., a bag), along with the bookmark components, or which may, in some embodiments, be printed directly on the package 1380. The instructions 1370 can include directions for performing any and/or all of the steps or stages of a method for attaching the ribbon 1340 to the base 1301, such as any of the procedures discussed above. In other or further embodiments, the instructions 1370 may provide directions for merely accessing such directions. For example, the instructions may list a web address, a mailing address, and/or a telephone number that can be used to locate instructions for assembling a bookmark.

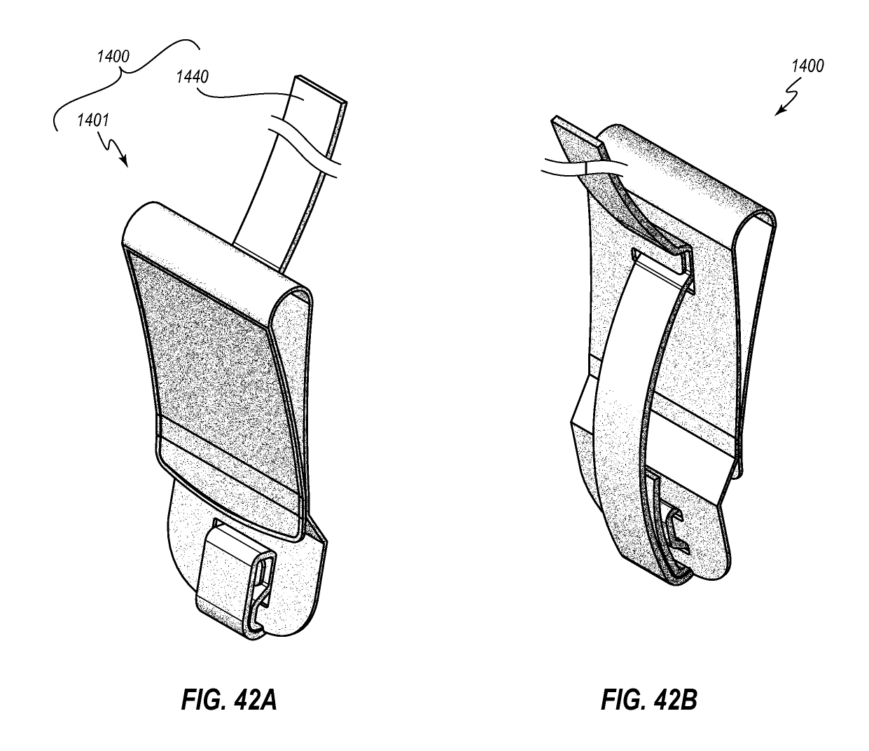

FIGS. 42A and 42B illustrate another embodiment of a bookmark 1400 that includes a base 1401 coupled with a ribbon 1440. Coupling of the ribbon 1440 to the base 1401 can be achieved in any suitable manner, such as any of the manners discussed above. In the illustrated embodiment, the ribbon 1440 is coupled to the base 1401 via frictional engagement without any adhesives or other fastening devices.

As shown in FIGS. 43A and 43B, the bookmark 1400 can be particularly suited for coupling with the cover 30 of a book 10. The cover 30 may be of a hardback or paperback variety, as further discussed below. In the illustrated embodiment, the cover 30 is a relatively thick hardback variety, and the bookmark 1400 is coupled with the front cover flap 20 of the book 10. As discussed further hereafter, the base 1401 can act as a clip. A first portion of the base 1401 can be visible at a front face of the book 10, and another portion of the base 1401 can be inserted between the front cover flap 20 of the book 10 and the pages of the book 10. Both portions of the base 1401 can cooperate to attach the bookmark 1400 to the cover 30. In some embodiments, the base 1401 is formed of a unitary piece of material.

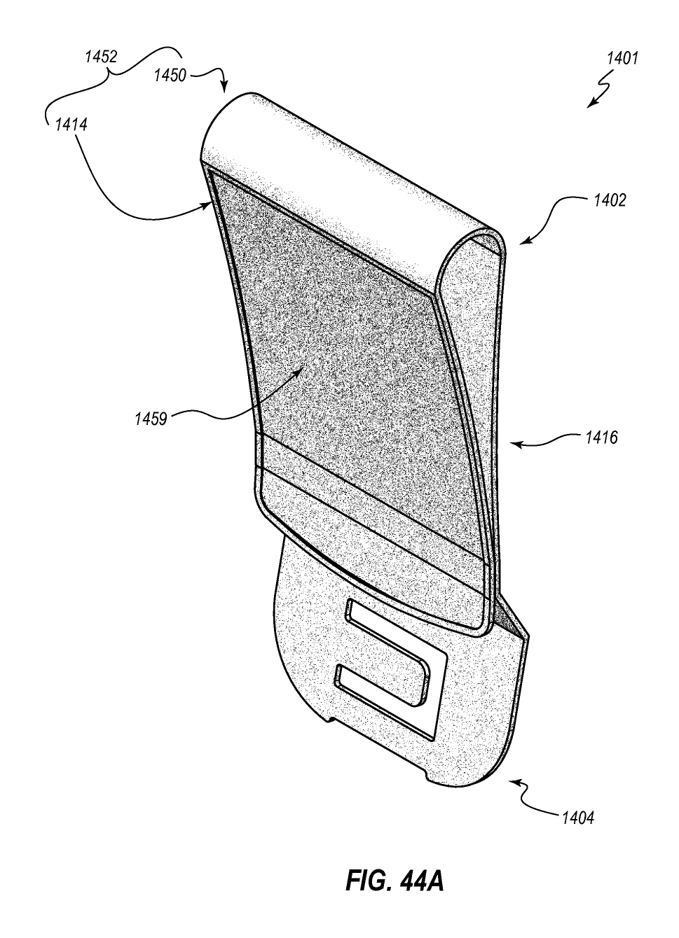

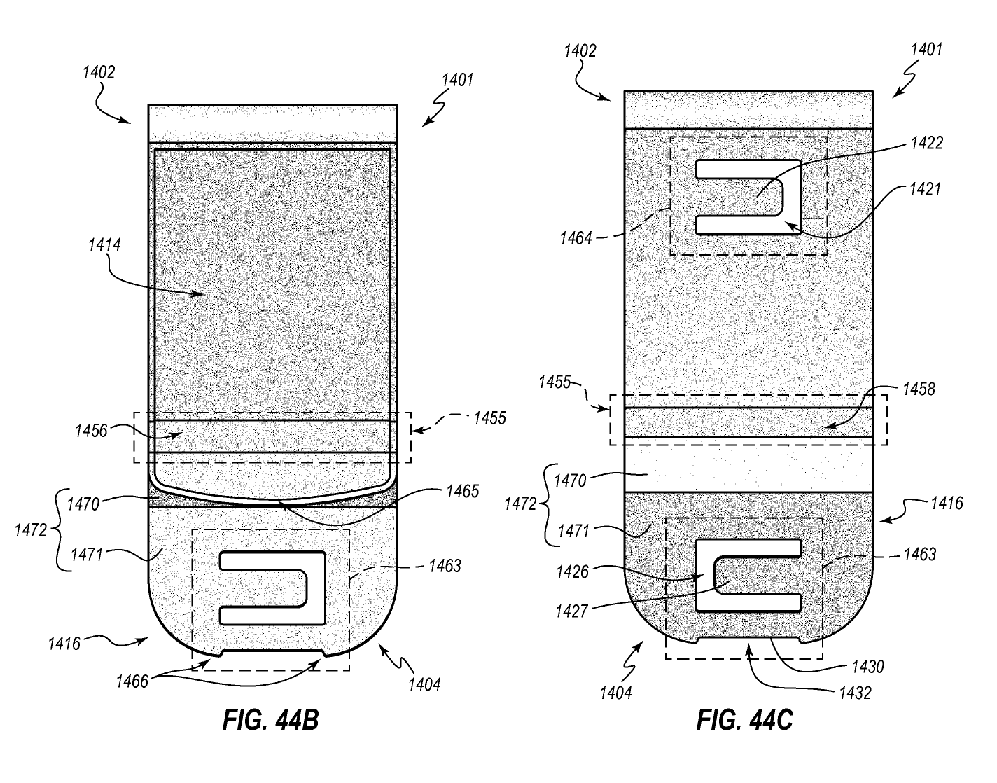

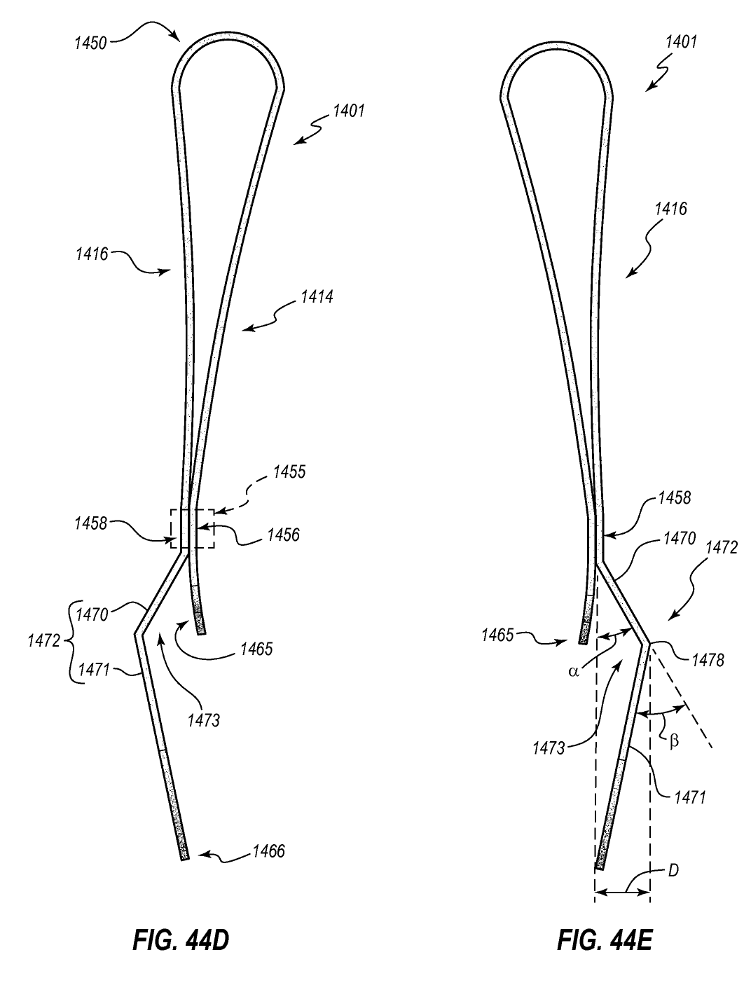

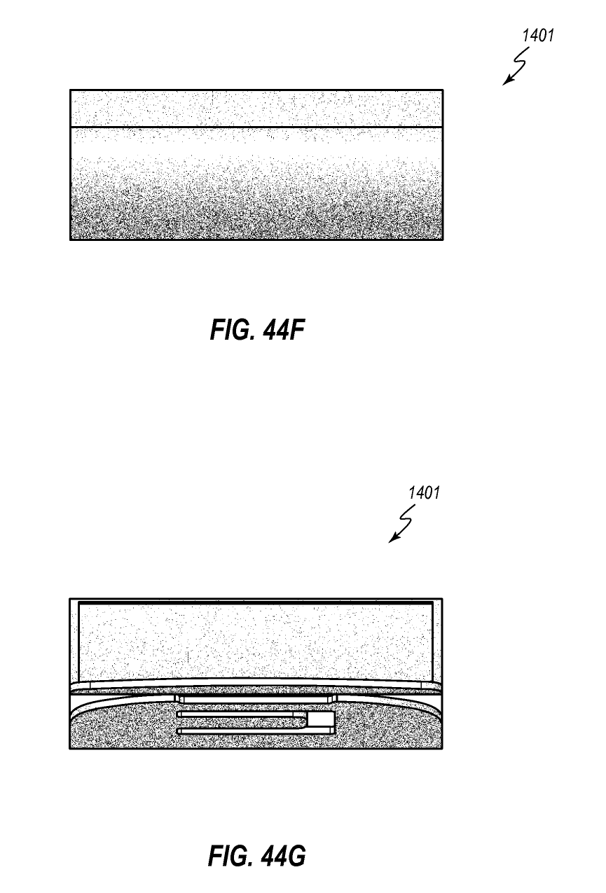

With reference to FIGS. 44A-44E, certain embodiments of the base 1401 include a clamp-like display body 1414, which can extend forwardly over the front cover flap 20 and cooperate with a rigid body 1416 to attach the bookmark 1400 to the cover flap 20. Together, the rigid body 1416 and the display body 1414 may be referred to as a clip.

The display body 1414 can be connected to the rigid body 1416 via a transition region 1450 at an upper end 1402 of the base 1401. In the illustrated embodiment, the transition region 1450 defines a rounded profile and extends from an upper end of the rigid body 1416 to an upper end of the display body 1414. The transition region 1450 can be resiliently deformable so as to bias a bottom end of the display body 1414 toward the rigid body 1416. Together, the transition region 1450 and the display body 1414 can be referred to as a biasing member 1452. In some embodiments, the rigid body 1416, the display body 1414, and the transition region 1450 may be unitarily formed of any suitable material, such as, for example, metal or plastic. The transition region 1450 may also be referred to as a hinge.

In a natural or resting state, the display body 1414 can be angled from the transition region 1450 toward a clamping region 1455. The clamping region 1455 can include a clamping portion 1456 of the display body 1414 that is configured to cooperate with a clamping portion 1458 of the rigid body 1416 to secure the base 1401 to the book 10. In the illustrated embodiment, the clamping portions 1456, 1458 are each substantially planar and rectangular and are configured to contact each other (see FIG. 44D) when they are in an approximated or initial state, in which the base 1401 has not yet been attached to a book. Such an arrangement can ensure that the clamping portions 1456, 1458 will each contact opposite sides of a cover of the book when the base 1401 is coupled with the book in a deployed, gripping, or clamping state. In other embodiments, the clamping portions 1456, 1458 may define other shapes or configurations. For example, the clamping portions 1456, 1458 may be rounded or otherwise non-planar and/or may not contact each other when they are in the approximated or initial state.

In the illustrated embodiment, a left edge and a right edge of the display body 1414 are substantially aligned with the left and right edges of the rigid body 1416, respectively. Moreover, the left and right edges of the display body 1414 and the rigid body 1416 are coextensive along a longitudinal length of the clamping region 1455. Stated otherwise, an effective area of the clamping region 1455 can extend along substantially a full width of the base 1401. Such an arrangement can provide for an even, consistent, or distributed attachment force.

The display body 1414 can include a display region 1459 at which any suitable display may be provided, such as, for example, on a plate, sticker, or other item that is initially separate from the display body 1414 and is attached to the display body 1414 in any suitable fashion (e.g., adhesives or welding). The display may be provided to the display region 1459 in any other suitable manner, such as by painting, or may be integral to or removed from the display body (e.g., raised features, stamped features, cutouts, or etchings). In the illustrated embodiment, a cavity or recess defines the display region 1459, which may be configured to receive a decorative sticker or plate.

With reference to FIG. 44C, the rigid body 1416 can define lower and upper attachment regions 1463, 1464 at which the ribbon 1440 can be secured to the rigid body 1416. Any suitable arrangement for the attachment regions 1463, 1464 is possible, including any of those discussed above. In the illustrated embodiment, the lower attachment region 1463 includes a lower opening 1426 that encompasses a free end of a lower shelf member 1427, and further includes a notch 1430 that defines a recess 1432 at a lower end 1404 of the base 1401. The upper attachment region 1464 includes an upper opening 1421 that encompasses a free end of an upper shelf member 1422.

As can be seen in FIG. 44B, a bottom end 1465 of the display body 1414 can be spaced from the lower attachment region 1463. This can permit the ribbon 1440 to be readily passed through the lower opening 1426 and looped about the lower shelf member 1427. Stated otherwise, the ribbon 1440 can be passed through the opening 1426 without hindrance from the display body 1414. A bottom end of the rigid body 1416 can include one or more end points 1466, which can be at the bottommost edge of the rigid body 1416. In the illustrated embodiment, two end points 1466 are at either side of the notch 1430.

As shown in FIGS. 44B-44D, the rigid body 1416 can define a rearward deviation or coupling assist region 1472, which can be configured to aid in coupling the bookmark 1400 to the book 10. In the illustrated embodiment, the coupling assist region 1472 includes an upper panel 1470 and a lower panel 1471. The upper panel 1470 extends rearwardly and downwardly away from a bottom end of the clamping region 1455. In particular, the upper panel 1470 extends rearwardly so as to be spaced from the bottom end 1465 of the display body 1414.

As shown in FIG. 44E, the upper panel 1470 can be substantially planar. The upper panel 1470 can define an angle a relative to a tangent line that extends from the clamping portion 1458 of the rigid body 1416. In the illustrated embodiment, the lower panel 1471 is also substantially planar. The lower panel 1471 defines an angle ,6 relative to the upper panel 1470. In the illustrated embodiment, the angle β is greater than the angle α. One or more of the upper and lower panels 1470 can define a slot, receptacle, recess, depression, gap, void, or cavity 1473 that provides an empty volume behind the bottom end 1465 of the display body 1414. As discussed further below, the cavity 1473 can be sized to receive an edge of a book cover 30 therein, and the upper and/or lower panels 1470, 1471 can assist in opening the clamping region 1455 so that the base 1401 can be advanced onto the book cover 30. The bottom end 1465 of the display body 1414 may curve forwardly, which may also assist in introducing the book cover 30 into the cavity 1473.

The coupling assist region 1472 can extend rearwardly relative to an upper portion of the rigid body 1416 so as to define a depth D. For example, in the illustrated embodiment, an apex line 1478 that extends along a back end of the upper and lower panels 1470, 1471 can be spaced from the tangent line that extends downwardly from the clamping portion 1458 by the depth D. The depth D can be greater than an thickness of the rigid body 1416. For example, in various embodiments, the depth D is no less than about 11.5, 12.0, 12.5, 13.0, 13.5, or 14.0 times greater than a maximum thickness of the rigid body 1416.

Additional views of the base 1401 are provided in FIGS. 44F and 44G. FIG. 44F is a top plan view, and FIG. 44G is a bottom plan view.

FIGS. 45A-45D depict various stages of an illustrative procedure for coupling the bookmark 1400 with a cover 30 of a book 10. In the illustrated procedure, the bookmark 1400 is coupled with the front cover flap 20 of the book, although other suitable coupling positions are also possible. It is noted that in FIGS. 45A-45C, the ribbon 1440 is shown in a somewhat loose position, whereas in FIG. 45D, the ribbon 1440 has been tightened. In other procedures, it can be desirable to tighten the ribbon 1440 prior to coupling the bookmark 1400 with the book 10 (e.g., prior to the stage illustrated in FIG. 45A).

With reference to FIG. 45A, the base 1401 of the bookmark 1400 is tilted forward, such that the lower panel 1471 of the rigid body 1416 is parallel or nearly parallel to the front cover flap 20. Such an orientation can facilitate introduction of an upper end of the front cover flap 20 into the cavity 1473. The upper end of the front cover flap 20 can desirably be advanced between the bottom end 1465 of the display body 1414 and the lower panel 1471 of the rigid body 1416.

The bookmark 1400 can be advanced downwardly, as indicated by the bolded arrow. In FIG. 45A, the bookmark 1400 is shown just before the top edge of the front cover flap 20 comes into contact with the upper panel 1471 of the rigid body 1416. Moreover, the clamping region 1455 is shown in a non-separated, closed, or initial state, in which the front and rear clamping portions 1456, 1458 are in contact with, or in close proximity to, each other.

FIG. 45B depicts a later stage of the coupling of the bookmark 1400 with the front cover flap 20. To arrive at this stage, the base 1401 is urged downward even further such that the top edge of the front cover flap 20 contacts the upper panel 1471 of the rigid body 1416. Due to the slanted arrangement of the upper panel 1471, continued downward movement of the bookmark 1400 causes the top edge of the front cover flap 20 to pry or otherwise urge apart the front and rear clamping portions 1456, 1458.

In addition to being moved downwardly relative to the front cover flap 20, the base 1401 may also be rotated rearwardly, as indicated by the bolded arrow. Such movement can assist in opening the clamping region 1455. This movement can also bring the end points 1466 of the rigid body 1416 in contact with or in close proximity to the rear face of the front cover flap 20. For example, in some embodiments, the ribbon 1440 is thick enough to prevent to the end points 1466 from contacting the front cover flap 20. The ribbon 1440 may be soft and/or the end points 1466 may be rounded or otherwise configured so as not to leave any marks or creases at the inner face of the front cover flap 20.

In some arrangements, rotating the base 1401 rearwardly can assist in opening the clamping region 1455, as the lower end of the rigid body 1416 can act as a pivot and cause the upper end of the front cover flap 20 to move the display body 1414 forwardly. However, in other arrangements, the base 1401 may be inserted over the front cover flap 20 with relatively little or no rotation. For example, the angled surface of the upper panel 1470 and/or the forwardly curved bottom end 1465 of the display body 1414 can provide clearance for a thickness of the front cover flap 20, such that the base 1401 may be translated downwardly without rotation. In certain of such arrangements, interaction between the upper end of the front cover flap 20 and the angled upper panel 1470 can cause the clamping portions 1456, 1458 to separate from each other and permit the base 1401 to be further advanced over the front cover flap 20.

With reference to FIG. 45C, the body 1401 can be advanced further onto the front cover flap 20. In the illustrated arrangement, the top edge of the front cover flap 20 can contact an interior surface of the transition region 1450. This additional contact may provide stability to the body 1401, which also clamps the front cover flap 20 between the front and rear clamping portions 1456, 1458.

As shown in FIG. 45D, the book 10 can be closed after the bookmark 1400 has been secured to front cover flap 20. Due to the depth D that results from the coupling assist region 1472, the cover flap 20 may be spaced further from the pages 50 of the book 10 than it would be in the absence of the bookmark 1400. Accordingly, in some embodiments, it may be desirable for the depth D to be relatively small such that the front cover flap 20 is raised by only a small or negligible amount when the book 10 is closed. In some embodiments, the depth D can be adjustable. For example, the rigid body 1416 may be relatively rigid in a longitudinal direction, but more flexible in the depth direction such that the coupling assist region 1472 may be readily compressed between the front cover flap 20 and the pages 59. However, in other embodiments, the coupling assist region 1472 may be relatively inflexible. In various embodiments, the depth D may be no greater than about 11, 12, 13, or 14 millimeters.

From the foregoing disclosure, it can be appreciated that the bookmark 1400 can be readily coupled with either hardback or paperback books. Various arrangements, such as those described, can allow for simple coupling of the bookmark 1400 with the cover 30 such that a top edge of the cover 30 is not damaged by the coupling, which may be particularly advantageous for paperback books. Moreover, the arrangements can be particularly well-suited for coupling the bookmark 1400 with hardback covers 52, which may be relatively thicker. Such advantages can result from the coupling assist region 1472 as previously described.

Other arrangements than those specifically described and illustrated in the drawings will be evident based on the present disclosure. For example, although the upper and lower panels 1470, 1471 are described as being planar in some embodiments, in other embodiments, the panels 1470, 1471 may be rounded or otherwise nonplanar. For example, one or more of the panels 1470, 1471 may be replaced with a convexly rounded region.

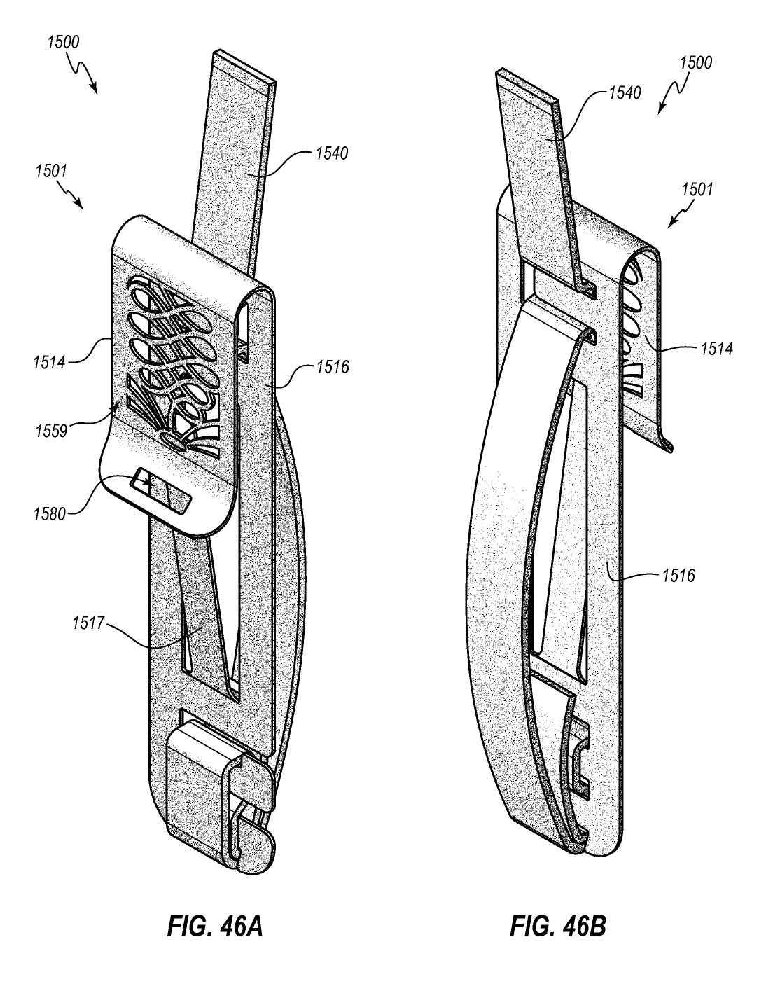

FIGS. 46A and 46B illustrate an embodiment of a bookmark 1500, which can particularly resemble the bookmark 1100 described above. The bookmark 1500 includes a base 1501 that can be coupled with a ribbon 1540 in any suitable manner. The base 1501 can include a display body 1514, a rigid body 1516, and a spring member 1517. The display body 1514 can include a display region 1559, which, in the illustrated embodiment, includes a cutout design. In some embodiments, a lower end of the display body 1514 can curve forwardly. In other or further embodiments, the lower end of the display body 1514 can define an attachment port 1580, at which any suitable ornamental feature can be attached to the display body 1514. For example, in some embodiments, a charm may be clipped to the display body 1514 at the attachment port 1580.

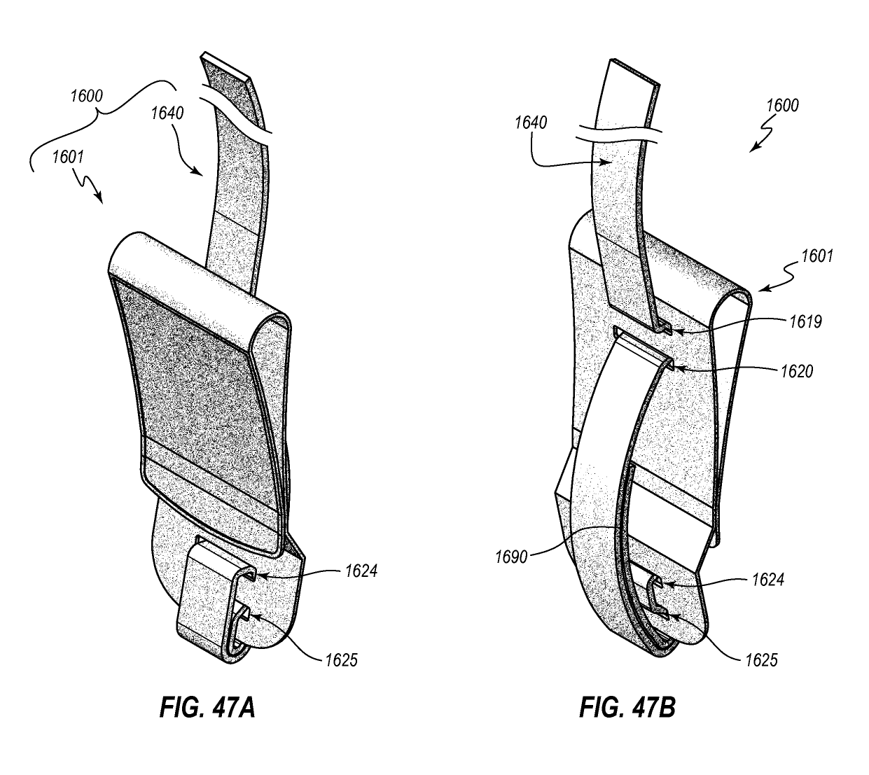

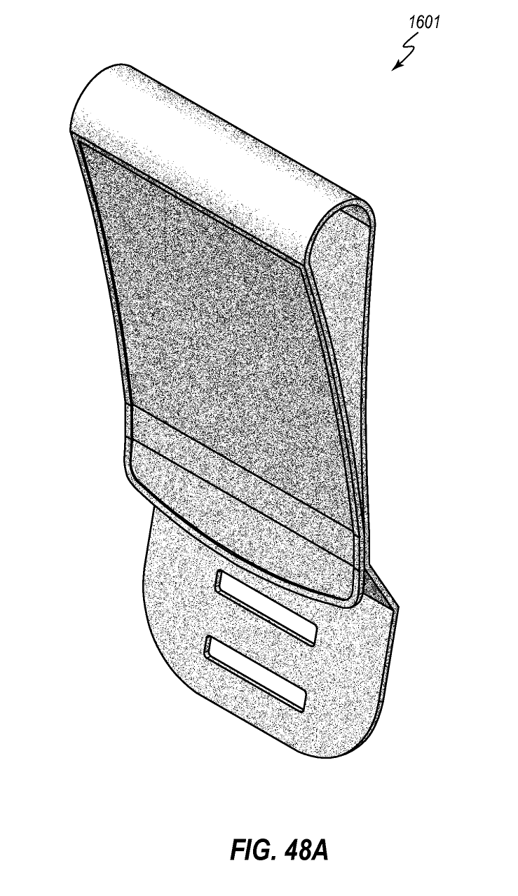

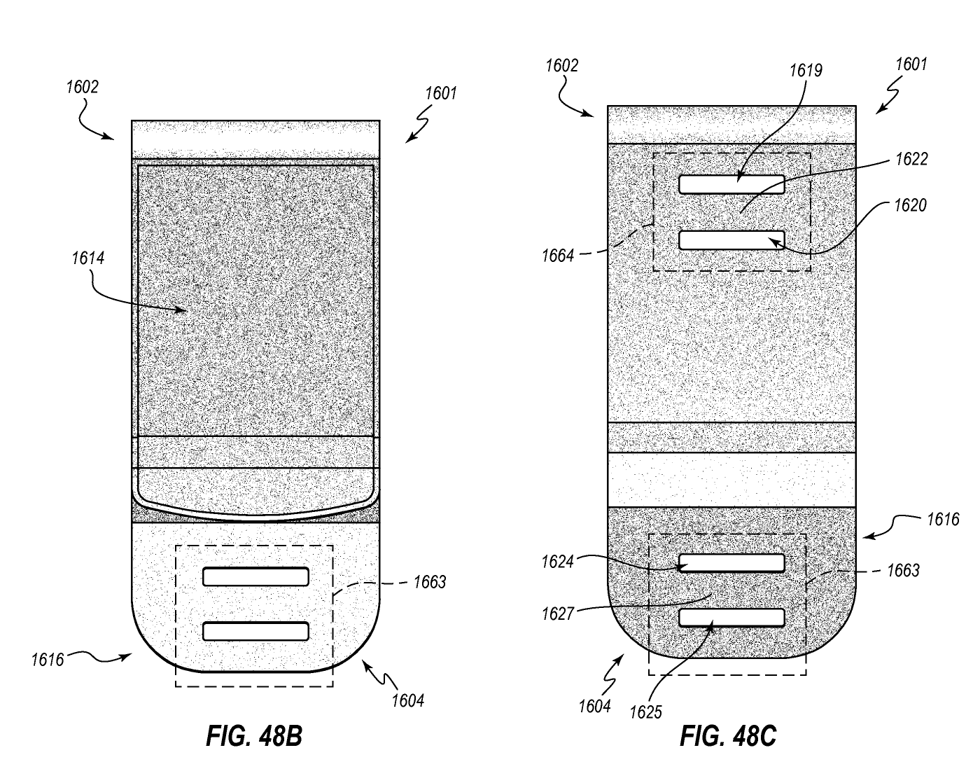

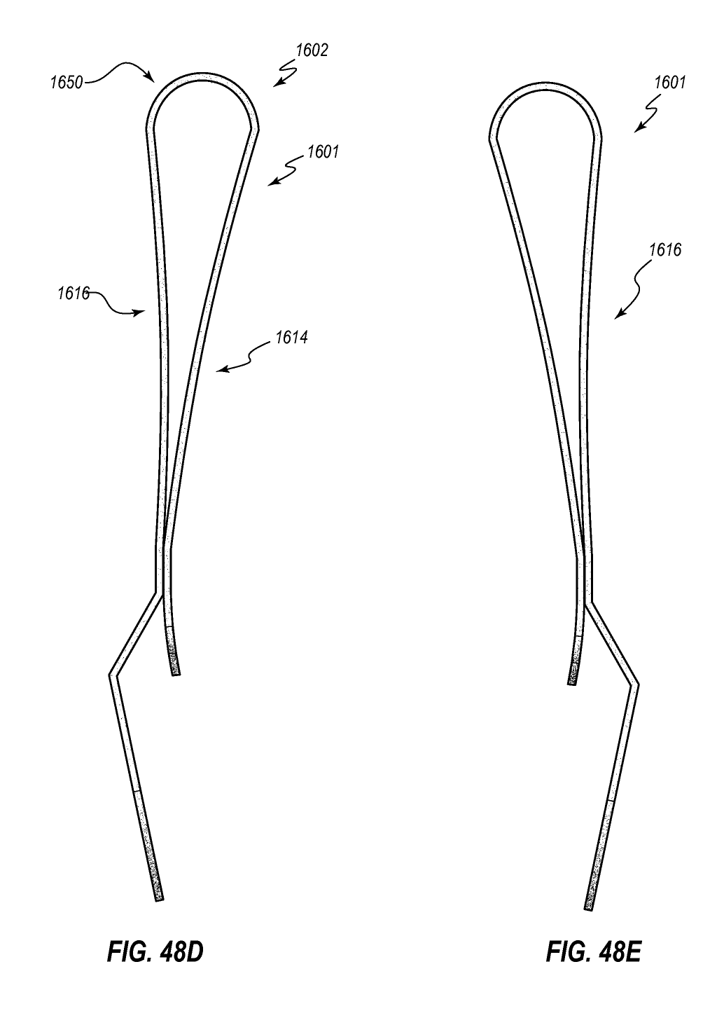

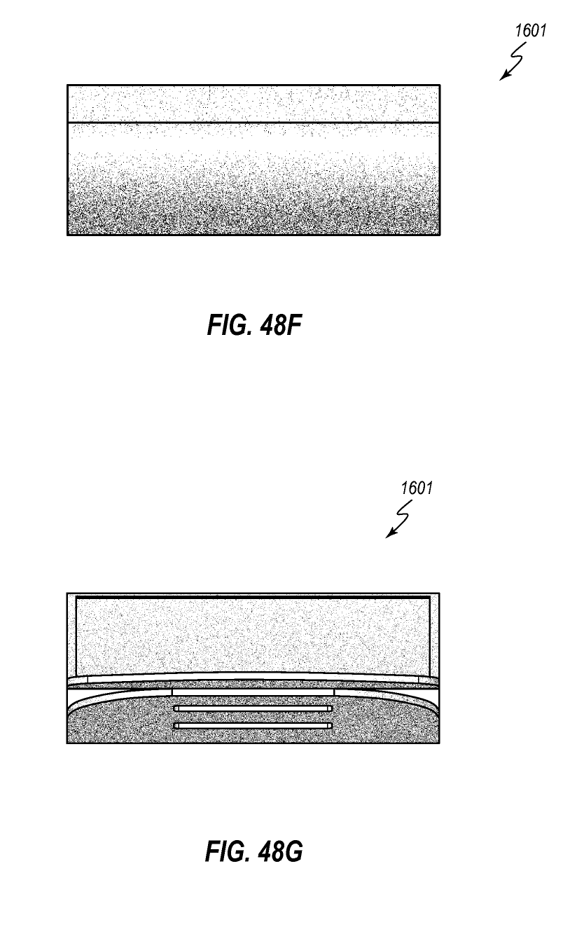

FIGS. 47A-48G illustrate another embodiment of a bookmark 1600, which can be similar to the bookmark 1400 depicted in FIGS. 42A-45D. The bookmark 1600 can differ in certain respects, however, as will be apparent from the discussion that follows.

FIGS. 47A and 47B depict a base 1601 and a ribbon 1640 that are coupled with each other. The bookmark 1600 thus comprises the base 1601 and the ribbon 1640. In the illustrated embodiment, the ribbon 1640 is attached to itself via any suitable fastener 1690, such as an adhesive (e.g., glue or double-sided tape). Such a fastener 1690 may also be used with any of the embodiments depicted in FIGS. 30A-46B. In the illustrated embodiment, two segments of the ribbon 1640 extend forwardly through openings 1624, 1625 at a bottom end of the base 1601, with the segment that extends through the opening 1624 being significantly shorter than the segment that extends through the opening 1625. Both segments of the ribbon 1640 are wrapped around a bottom edge of the base 1601 in a rearward direction. The segments are adhered to each other via the fastener 1690, and one of the segments is long enough to continue through upper openings 1620, 1619. The elongated end of the segment that exits the opening 1619 away from the base 1601 can be used for marking a place in a book.

In other embodiments, the segments of the ribbon 1640 are not wrapped around the bottom edge end of the base 1601. For example, in some embodiments, the segments initially extend rearwardly through the lower openings 1624, 1625 in a manner opposite from that shown in FIGS. 47A and 47B.

With reference to FIGS. 48A-48G, the base 1601 can resemble the base 1401 in many respects. For example, the base 1601 includes a display body 1614 and a rigid body 1616 that are coupled to each other via a transition region 1650 at an upper end 1602 of the base 1601. However, the base 1601 does not include a notch or recess at its lower end 1604. Moreover, upper and lower attachment regions 1664, 1663 of the rigid body 1616 differ somewhat from the illustrated upper and lower attachment regions 1464, 1463. In particular, upper and lower shelf members 1622, 1627 do not include free ends, unlike the illustrated shelf members 1422, 1427. Rather, the shelf members 1622, 1627 are integral with surrounding portions of the rigid body 1616 at each lateral end of the respective shelf member 1622, 1627. Accordingly, each opening 1619, 1620, 1624, 1625 is a discrete opening and is fully encompassed by the material of which the rigid body 1616 is formed.

It will be understood by those having skill in the art that changes may be made to the details of the above-described embodiments without departing from the underlying principles presented herein. For example, any suitable combination of various embodiments, or the features thereof, is contemplated. Additional embodiments of bookmarks with which features disclosed herein may be used are disclosed in U.S. Design Patent Nos. D624,587; D624,588; D624,589; D624,590; D629,844; D629,845; D632,331; and D634,363, the entire contents of each of which are hereby incorporated by reference herein. For example, any suitable ribbon arrangement from the foregoing applications and patents may be used with any of the bookmark bases disclosed herein. Thus, any of the views of the ribbons shown in the foregoing design patents can be used with corresponding views of the bases disclosed herein.

Any methods disclosed herein comprise one or more steps or actions for performing the described method. The method steps and/or actions may be interchanged with one another. In other words, unless a specific order of steps or actions is required for proper operation of the embodiment, the order and/or use of specific steps and/or actions may be modified.

Reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that in the above description of embodiments, various features are sometimes grouped together in a single embodiment, figure, or description thereof for the purpose of streamlining the disclosure. This method of disclosure, however, is not to be interpreted as reflecting an intention that any claim require more features than those expressly recited in that claim. Rather, as the following claims reflect, inventive aspects lie in a combination of fewer than all features of any single foregoing disclosed embodiment.

The claims following this written disclosure are hereby expressly incorporated into the present written disclosure, with each claim standing on its own as a separate embodiment. This disclosure includes all permutations of the independent claims with their dependent claims.

Recitation in the claims of the term “first” with respect to a feature or element does not necessarily imply the existence of a second or additional such feature or element. Elements specifically recited in means-plus-function format, if any, are intended to be construed in accordance with 35 U.S.C. §112(f). Embodiments of the invention in which an exclusive property or privilege is claimed are defined as follows.

1. A bookmark comprising:
a clip comprising:
a rigid body defining an upper end and a lower edge, the rigid body comprising a clamping region, an upper attachment region, and a lower attachment region, wherein the lower attachment region comprises a shelf member; and
a display body resiliently coupled with the upper end of the rigid body, wherein the display body comprises a clamping region that is configured to cooperate with the clamping region of the rigid body to attach the clip to a book cover when the book cover is inserted between the rigid body and the display body; and
a ribbon that extends through the rigid body of the clip at each of the upper and lower attachment regions to couple the ribbon to the rigid body, wherein a first portion of the ribbon extends from the upper attachment region to be positioned between pages of a book when the clip is attached to the book, and wherein a second portion of the ribbon is looped about the shelf member of the lower attachment region.

2. The bookmark of claim 1, wherein the second portion of the ribbon comprises an end of the ribbon, and wherein the end of the ribbon is attached to an intermediate segment of the ribbon that extends between the upper and lower attachment regions of the rigid body such that the end of the ribbon does not extend below the lower edge of the rigid body of the clip.

3. The bookmark of claim 1, wherein the clamping region of the rigid body is positioned between the upper and lower attachment regions of the rigid body.

4. The bookmark of claim 1, wherein each of the upper and lower attachment regions comprises two openings extending through the rigid body, and wherein the ribbon passes through each of the two openings in each of the upper and lower attachment regions.

5. The bookmark of claim 1, wherein the second portion of the ribbon comprises two regions that are attached to each other at one side of the rigid body.

6. The bookmark of claim 5, further comprising an adhesive, wherein the two regions of the second portion of the ribbon are attached to each other via the adhesive.

7. The bookmark of claim 1, wherein the rigid body further comprises a coupling assist region that comprises a cavity that extends rearwardly relative to the display body, wherein the cavity is positioned below the clamping region of the rigid body such that an edge of a book cover can be received into the cavity before being advanced between the clamping region of the rigid body and the clamping region of the display body.

8. A bookmark comprising:
a clip comprising:
a rigid body defining an upper end and a lower edge, the rigid body comprising a clamping region, an upper attachment region, and a lower attachment region, wherein the lower attachment region comprises a shelf member; and
a display body resiliently coupled with the upper end of the rigid body, wherein the display body comprises a clamping region that is configured to cooperate with the clamping region of the rigid body to attach the clip to a book cover when the book cover is inserted to between the rigid body and the display body; and
a ribbon that extends through the rigid body of the clip at each of the upper and lower attachment regions to couple the ribbon to the rigid body, wherein a portion of the ribbon is looped about the shelf member of the lower attachment region, and wherein an end of the ribbon is attached to an intermediate segment of the ribbon that extends between the upper and lower attachment regions.

9. The bookmark of claim 8, wherein when a book to which the clip is attached is closed, the end of the ribbon that is attached to the intermediate segment of the ribbon is hidden from view.

10. The bookmark of claim 8, wherein the ribbon is non-resilient.

11. The bookmark of claim 8, wherein the clamping region of the rigid body is positioned between the upper and lower attachment regions of the rigid body.

12. The bookmark of claim 8, wherein each of the upper and lower attachment regions comprises two openings extending through the rigid body, and wherein the ribbon passes through each of the two openings in each of the upper and lower attachment regions.

13. The bookmark of claim 8, wherein the end of the ribbon is attached to the intermediate segment of the ribbon via an adhesive.

14. The bookmark of claim 8, wherein the rigid body further comprises a coupling assist region that comprises a cavity that extends rearwardly relative to the display body, wherein the cavity is positioned below the clamping region of the rigid body such that an edge of a book cover can be received into the cavity before being advanced between the clamping region of the rigid body and the clamping region of the display body.
